(19) United States
(12) Patent Application Publication
(10) Pub. No.: US 2026/0081654 A1
(43) Pub. Date: Mar. 19, 2026

(54) BEAM STEERING ADJUSTMENTS FOR MULTI-PANEL ANTENNA ARRAYS

(71) Applicant: QUALCOMM Incorporated, San Diego, CA (US)

(72) Inventors: Vasanthan RAGHAVAN, West Windsor Township, NJ (US); Andrew ARNETT, San Diego, CA (US); Kiran VENUGOPAL, Green Brook, NJ (US)

(21) Appl. No.: 18/886,755

(22) Filed: Sep. 16, 2024

(51) Int. Cl. H04B 7/06; H04B 7/0456; H04L 5/00

(52) U.S. Cl. CPC H04B 7/0617; H04B 7/0469; H04B 7/0632; H04L 5/0048

(57) ABSTRACT

Certain aspects of the present disclosure provide techniques for beam steering. A method generally includes obtaining a first signal communicated according to a first polarization; obtaining a second signal communicated according to a second polarization; and transmitting an indication of an imbalance between a signal strength of the first signal and a signal strength of the second signal.

### INTRODUCTION

### Field of the Disclosure

Aspects of the present disclosure relate to wireless communications, and more particularly, to techniques for beam steering with multi-panel antenna arrays.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by an apparatus. The method includes obtaining a first signal communicated according to a first polarization; obtaining a second signal communicated according to a second polarization; and transmitting an indication of an imbalance between a signal strength of the first signal and a signal strength of the second signal.

Another aspect provides one or more apparatuses configured for wireless communications. The one or more apparatuses include one or more memories and one or more processors, coupled to the one or more memories, configured to cause the one or more apparatuses to obtain a first signal communicated according to a first polarization; obtain a second signal communicated according to a second polarization; and transmit an indication of an imbalance between a signal strength of the first signal and a signal strength of the second signal.

Another aspect provides one or more apparatuses configured for wireless communications. The one or more apparatuses include means for obtaining a first signal communicated according to a first polarization; means for obtaining a second signal communicated according to a second polarization; and means for transmitting an indication of an imbalance between a signal strength of the first signal and a signal strength of the second signal.

Another aspect provides one or more non-transitory computer-readable media. The one or more non-transitory computer-readable media include executable instructions that, when executed by one or more processors of one or more apparatuses, cause the one or more apparatuses to obtain a first signal communicated according to a first polarization; obtain a second signal communicated according to a second polarization; and transmit an indication of an imbalance between a signal strength of the first signal and a signal strength of the second signal.

In some examples of the methods, apparatuses, and non-transitory computer-readable media described herein, the indication of the imbalance indicates that a difference between the signal strength of the first signal and the signal strength of the second signal satisfies a threshold.

In some examples of the methods, apparatuses, and non-transitory computer-readable media described herein, the first signal is associated with a first antenna panel of a node and the second signal is associated with a second antenna panel of the node.

In some examples of the methods, apparatuses, and non-transitory computer-readable media described herein, each of the first antenna panel and the second antenna panel comprises: a uni-polarized array; or a dual-polarized array.

Some examples of the methods, apparatuses, and non-transitory computer-readable media described herein may further include operations, features, means, or instructions for obtaining a first reference signal at a first position of the apparatus; obtaining a second reference signal at a second position of the apparatus; obtaining a third reference signal; and obtaining a fourth reference signal.

In some examples of the methods, apparatuses, and non-transitory computer-readable media described herein, the first reference signal, the second reference signal, and the third reference signal are associated with a first antenna panel of a node; and the fourth reference signal is associated with a second antenna panel of the node.

Some examples of the methods, apparatuses, and non-transitory computer-readable media described herein may further include operations, features, means, or instructions for transmitting an indication of a path loss estimate.

In some examples of the methods, apparatuses, and non-transitory computer-readable media described herein, the path loss estimate is based on a signal strength of the first reference signal, a signal strength of the second reference signal, and a distance between the first position and the second position.

Some examples of the methods, apparatuses, and non-transitory computer-readable media described herein may further include operations, features, means, or instructions for transmitting an indication of a differential signal strength between a signal strength of the third reference signal and a signal strength of the fourth reference signal.

Some examples of the methods, apparatuses, and non-transitory computer-readable media described herein may further include operations, features, means, or instructions for transmitting a first estimated distance between a center of a first antenna panel of a node and the apparatus.

Some examples of the methods, apparatuses, and non-transitory computer-readable media described herein may further include operations, features, means, or instructions for transmitting second estimated distance between a center of a second antenna panel of the node and the apparatus.

In some examples of the methods, apparatuses, and non-transitory computer-readable media described herein, the second estimated distance is based on a signal strength of the first reference signal, a signal strength of the second reference signal, a distance between the first position and the second position, a signal strength of the third reference signal, and a signal strength of the fourth reference signal.

Some examples of the methods, apparatuses, and non-transitory computer-readable media described herein may further include operations, features, means, or instructions for obtaining a first reference signal; obtaining a second reference signal; and transmitting an indication of an observed time difference of arrival associated with the first reference signal and the second reference signal.

In some examples of the methods, apparatuses, and non-transitory computer-readable media described herein, the first reference signal is associated with a first antenna panel of a node and the second reference signal is associated with a second antenna panel of the node.

Another aspect provides a method for wireless communication by an apparatus. The method includes transmitting a first signal according to a first polarization; transmitting a second signal according to a second polarization; and obtaining an indication of an imbalance between a signal strength of the first signal and a signal strength of the second signal.

Another aspect provides one or more apparatuses configured for wireless communications. The one or more apparatuses include one or more memories and one or more processors, coupled to the one or more memories, configured to cause the one or more apparatuses to transmit a first signal according to a first polarization; transmit a second signal according to a second polarization; and obtain an indication of an imbalance between a signal strength of the first signal and a signal strength of the second signal.

Another aspect provides one or more apparatuses configured for wireless communications. The one or more apparatuses include means for transmitting a first signal according to a first polarization; means for transmitting a second signal according to a second polarization; and means for obtaining an indication of an imbalance between a signal strength of the first signal and a signal strength of the second signal.

Another aspect provides one or more non-transitory computer-readable media. The one or more non-transitory computer-readable media include executable instructions that, when executed by one or more processors of one or more apparatuses, cause the one or more apparatuses to transmit a first signal according to a first polarization; transmit a second signal according to a second polarization; and obtain an indication of an imbalance between a signal strength of the first signal and a signal strength of the second signal.

In some examples of the methods, apparatuses, and non-transitory computer-readable media described herein, the indication of the imbalance indicates that a difference in the signal strength of the first signal and the signal strength of the second signal satisfies a threshold.

In some examples of the methods, apparatuses, and non-transitory computer-readable media described herein, the first signal is associated with a first antenna panel of the apparatus and the second signal is associated with a second antenna panel of the apparatus.

In some examples of the methods, apparatuses, and non-transitory computer-readable media described herein, each of the first antenna panel and the second antenna panel comprises: a uni-polarized antenna array; or a dual-polarized antenna array.

Some examples of the methods, apparatuses, and non-transitory computer-readable media described herein may further include operations, features, means, or instructions for transmitting a first reference signal; transmitting a second reference signal; transmitting a third reference signal; and transmitting a fourth reference signal.

In some examples of the methods, apparatuses, and non-transitory computer-readable media described herein, the first reference signal, the second reference signal, and the third reference signal are sent from a first antenna panel of the apparatus; and the fourth reference signal is transmitted from a second antenna panel of the apparatus.

Some examples of the methods, apparatuses, and non-transitory computer-readable media described herein may further include operations, features, means, or instructions for obtaining, based on transmitting the first reference signal and the second reference signal, an indication of a path loss estimate.

Some examples of the methods, apparatuses, and non-transitory computer-readable media described herein may further include operations, features, means, or instructions for obtaining an indication of a differential signal strength between a signal strength of the third reference signal and a signal strength of the fourth reference signal.

Some examples of the methods, apparatuses, and non-transitory computer-readable media described herein may further include operations, features, means, or instructions for: obtaining an indication of a first estimated distance between a center of a first antenna panel of the apparatus and a node; determining a distance ratio of the first estimated distance to a second estimated distance between a center of a second antenna panel of the apparatus and the node based on the path loss estimate and the differential signal strength; determining the second estimated distance based on the first estimated distance and the distance ratio; transmitting a third signal from the first antenna panel of the apparatus according to a first direction, wherein the first direction is based on a transmission configuration indication state; and transmitting a fourth signal from the second antenna panel of the apparatus according to a second direction, wherein the second direction is based on the first estimated distance, the second estimate distance, and a distance between the center of the first antenna panel to the center of the second antenna panel.

Some examples of the methods, apparatuses, and non-transitory computer-readable media described herein may further include operations, features, means, or instructions for obtaining a first estimated distance between a center of a first antenna panel of the apparatus and a node and a second estimated distance between a center of a second antenna panel of the apparatus and the node.

Some examples of the methods, apparatuses, and non-transitory computer-readable media described herein may further include operations, features, means, or instructions for: transmitting a third signal from the first antenna panel of the apparatus according to a first direction, wherein the first direction is based on a transmission configuration indication state; and transmitting a fourth signal from the second antenna panel of the apparatus according to a second direction, wherein the second direction is based on the first estimated distance, the second estimate distance, and a distance between the center of the first antenna panel to the center of the second antenna panel.

Some examples of the methods, apparatuses, and non-transitory computer-readable media described herein may further include operations, features, means, or instructions for: transmitting a first reference signal; transmitting a second reference signal; and obtaining an indication of a respective observed time difference of arrival associated with each of the first reference signal and the second reference signal.

In some examples of the methods, apparatuses, and non-transitory computer-readable media described herein, the first reference signal is associated with a first antenna panel of the apparatus and the second reference signal is associated with a second antenna panel of the apparatus.

Some examples of the methods, apparatuses, and non-transitory computer-readable media described herein may further include operations, features, means, or instructions for: determining a difference between the respective observed time difference of arrival associated with the first reference signal and the respective observed time difference of arrival associated with the second reference signal; transmitting a third signal from a first antenna panel according to a first direction, wherein the first direction is based on a transmission configuration indication state; and transmitting a fourth signal from a second antenna panel of the apparatus according to a second direction, wherein the second direction is based on the difference.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts example multiple antenna panel designs for antenna arrays.

FIG. 6 depicts example transmissions using antenna arrays with co-located uni-polarized antenna panels.

FIG. 7 depicts example discrepancy in directions of transmissions from two antenna panels.

FIG. 8 depicts a process flow for communications in a network between a transmit node and a receive node to trigger beam steering angle adjustments for transmission at a transmit node using multiple antenna panels.

FIGS. 9A and 9B depict process flows for communications in a network between a transmit node and a receive node to determine beam steering angle adjustments for transmission at a transmit node using multiple antenna panels.

FIG. 10 depicts another process flow for communications in a network between a transmit node and a receive node to determine beam steering angle adjustments for transmission at a transmit node using multiple antenna panels.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for beam steering adjustment, including adjusting a beam used for the transmission of a wireless signal, to a receive node, from an antenna array implemented at a transmit node with multiple non-co-located antenna panels. Two antenna panels may be said to be “non-co-located” when their centers are not aligned and/or do not coincide, such that a center of the first antenna panel is separated from a center of the second antenna panel by a distance (d). For example, aspects herein provide signaling mechanisms for determining a beam to use for communicating wireless signal(s), to a receive node, from one of the two antenna panels based on a beam used for communicating wireless signal(s), to the receive node, from the other wireless panel, such that the antenna panels use different beams. Put differently, a first beam (e.g., associated with a first beam steering angle) used to transmit a first wireless signal from a first antenna panel at the transmit node may be different than a second beam (e.g., associated with a second beam steering angle) used to transmit a second wireless signal from a second antenna panel at the transmit node to effectively steer the wireless signals from the two antenna panels in a same direction, such as towards the receive node, although the antenna panels are not aligned.

Communications using higher frequency bands, such as Frequency Range 2 (FR2) (e.g., millimeter wave (mmWave)) bands above 24.25 gigahertz (GHz), may experience higher path loss and/or a shorter range compared to lower frequency communications. Thus, nodes communicating via these frequencies may include multiple antenna elements and utilize beamforming, which is a technique that leverages the multiple antenna elements at the nodes to focus wireless signals between the nodes.

For example, the amplitudes and/or phases of signals transmitted via antenna elements at a node may be modulated and shifted relative to each other (e.g., such as by manipulating phase shifts, phase offsets, and/or amplitudes) to generate one or more beams, which is referred to as “beamforming.” The term “beam” may refer to a directional transmission of a wireless signal towards a receiving node or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In certain aspects, antenna elements at the node may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) may be dynamically controlled by modifying the phase shifts, phase offsets, and/or amplitudes of the multiple signals relative to each other. Such beamforming techniques may be help to improve the signal-to-noise ratio (SNR), reduce path loss, and/or increase data rates for wireless communications, especially in mmWave operations.

In certain aspects, multiple antenna elements may support multiple-layer transmission, in which a first layer of a communication (e.g., which may include a first data stream) and a second layer of a communication (e.g., which may include a second data stream) are transmitted using the same time and frequency resources with spatial multiplexing. A spatial multiplexing scheme may be referred to as a multiple-input-multiple-output (MIMO) scheme, which may be used to further increase the spectral efficiency (e.g., a measure of a bit rate that is transmitted in a given communication channel).

Different nodes may include different numbers of antenna elements for beamforming and/or MIMO operations. For example, a user equipment (UE) (e.g., a first example node) may include two antenna elements, four antenna elements, eight antenna elements, or a different number of antenna elements. As another example, a network entity (e.g., a second example node) may include eight antenna elements, 32 antenna elements, 64 antenna elements, 128 antenna elements, 512 antenna elements, or a different number of antenna elements. In certain aspects, a node's antenna elements may be included within an antenna array implemented at the node. An “antenna array” (also simply referred to herein as an “array”) may refer to a collection of antenna elements, commonly organized in an array of rows and columns, such as in an m×n rectangular matrix of discrete antenna elements.

In general, the performance of an antenna array may increase as the size of the antenna array and/or the number of antenna elements in the antenna array increases. For example, a large antenna array, deployed with hundreds of antenna elements (e.g., such as antenna arrays larger than or equal in size to a 64×8 antenna array having 512 antenna elements), may offer higher array gain and a more directional radiation pattern (e.g., making it more suitable for long-distance communication) than a small size antenna array. As such, larger antenna arrays may be more desired for next generations of wireless technologies (e.g., 6G), which may be required to simultaneously accommodate numerous applications requiring ultra-high data rates, while also ensuring extensive coverage and reliability.

Large antenna arrays may provide the aforementioned benefits, however at the expense of increased cost, power consumption, and complexity. Accordingly, from at least a cost savings perspective, in certain aspects, antenna arrays may be designed to include multiple antenna panels, where an “antenna panel” (also simply referred to herein as a “panel”) may refer to a smaller size antenna array.

In certain aspects, the multiple panels may include uni-polarized panel(s) with single polarization antenna elements, dual-polarized panel(s) with dual polarization antenna elements, or both. For a uni-polarized panel, electromagnetic waves (e.g., radio frequency (RF) signals) may be propagated in only one polarization, for example either horizontally polarized or vertically polarized. For example, uni-polarized antenna panels may transmit and receive wireless signals using two separate antennas. For a dual-polarized panel, on the other hand, electromagnetic waves may be propagated in two orthogonal polarizations, for example they may be horizontally and vertically polarized. The term “polarization,” as used herein, may refer to a spatial orientation of the electric field produced by a transmitting antenna element, or alternatively the relative spatial orientation of electrical and magnetic fields causing substantially maximal resonance of a receiving antenna. For example, in the absence of reflective surfaces, a dipole antenna may radiate an electric field that is oriented parallel to the radiating bodies of the antenna element. The term “horizontally polarized,” as used herein, may refer to electromagnetic waves associated with an electric field that oscillates in the horizontal direction (e.g., side-to-side in the horizontal plane), and the term “vertically polarized,” as used herein, may refer to electromagnetic waves associated with an electric field that oscillates in the vertical direction (e.g., up and down in the vertical plane).

In certain aspects, multiple panel (multi-panel) antenna arrays may include non-co-located panels. As used herein, non-co-located panels may include two panels that have their centers separated by a distance, referred to herein as “inter-panel separation.” In particular, a center of a first panel of an antenna array with non-co-located panels may be separated from a center of a second panel of the antenna array by a distance (d). As an illustrative example, two 32×8 antenna panels may be placed near one another to create a 64×8 antenna array; however, a center of each of the 32×8 antenna panels may be separated by a distance (e.g., their centers may not coincide).

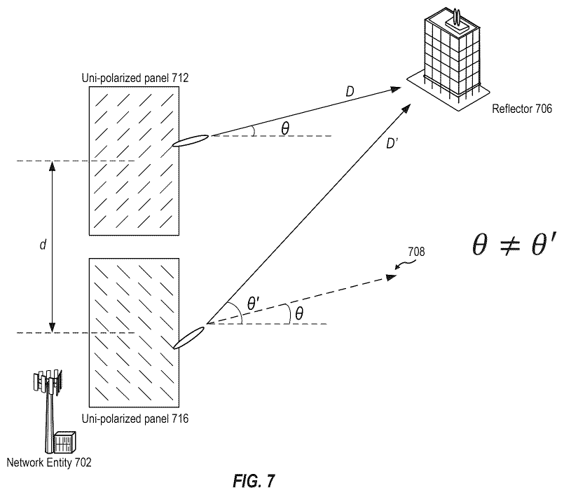

Inter-panel separation between panels of an (e.g., large) antenna array (e.g., at a transmit node) may present a technical problem for beamforming of dual-polarized transmissions (e.g., transmission from multiple uni-polarized or multiple dual-polarized panels). For example, as described below with respect to FIG. 7, conventional techniques may assume that a transmission configuration indicator (TCI) state, used to determine a beam for transmission, is common across polarizations. Thus, the common TCI state may be used to determine a common beam for the transmission of a wireless signal from each uni-polarized panel or each dual-polarized panel. A same beam used to transmit a wireless signal from each of the two panels, having their centers aligned, may result in the wireless signals being transmitted in a same direction to reach a same receiving node. However, a same beam used to transmit a wireless signal from each of the two panels, when the two panels are positioned with their centers a distance (d) apart, may result in the wireless signals being sent in different directions. Thus, beam steering of the signal from the transmit node to a receive node may be degraded, which may lead to a significant loss in communication performance. This problem may become even more of an issue when a large antenna array is implemented at the transmit node, such as with increased antenna panel sizes, due to at least a larger separation between the centers of the panels increasing the discrepancy in directions between the transmitted wireless signals.

Certain aspects described herein overcome the aforementioned technical problems associated with beam steering for non-co-located antenna panels, such as non-co-located antenna panels of a large antenna array, and provide a technical benefit to the field of telecommunications. For example, aspects described herein provide signaling mechanisms that enable beam steering adjustments for multi-panel antenna arrays. For example, a (e.g., large) multi-panel antenna array, implemented at a transmit node, may include two non-co-located panels, e.g., a first panel and a second panel. A steered beam may be determined for the first panel based on a TCI state (e.g., according to conventional techniques), while a modified steered beam may be determined for the second panel, such as to effectively beamform wireless signals in a single direction from the transmit node. The modified steered beam may be determined based on at least an inter-panel separation, or a distance (d) between a center of the first panel and a center of the second panel.

In some signaling designs described herein, the modified steered beam may be further determined based on a respective distance from each of the panels to the receive node. For example, a path loss may be estimated at the receive node based on the transmission of two signals, such as a first reference signal and a second reference signal, from the first panel at the transmit node, as the receive node moves from a first position to a second position. After determining the path loss, a differential signal strength (e.g., differential reference signal received power (ΔRSRP)) may be estimated at the receive node based on the transmission of a third reference signal from the first panel at the transmit node and a fourth reference signal from the second panel at the transmit node (e.g., while the receive node remains at the second position). In certain aspects, the receive node determines a first distance (D) from the first panel to the receive node and a second distance (D′) from the second panel to the receive node based on at least the estimated path loss and the differential signal strength. The receive node may then report, to the transmit node, these distances (e.g., D and D′) from the panels to the receive node, where they may be used by the transmit node for beam steering adjustment. Alternatively, in certain aspects, the transmit node determines the second distance (D′) from the second panel to the receive node, such as based on receiving indication(s) of the path loss estimate and the differential strength from the receive node. The transmit node may then use this second distance (D′), as well as the first distance (D) indicated to the transmit node by the receive node, for beam steering adjustment.

In some signaling designs described herein, the modified steered beam may be determined based on a first observed time difference of arrival (OTDOA) measurement for a transmission from the first panel towards the receive node and a second OTDOA measurement for a transmission from the second panel towards the receive node. For example, the receive node may determine the first OTDOA based on a time of arrival (TOA) of a first reference signal at the receive node and a time of transmission when the first reference signal was sent to the receive node via the first panel. Similarly, the receive node may determine the second OTDOA based on a TOA at the receive node and a time of transmission when the second reference signal was sent to the receive node via the second panel. The receive node may transmit an indication of the first OTDOA and the second OTDOA to the transmit node. The transmit node may use the first OTDOA and the second OTDOA to determine a ΔOTDOA (e.g., a difference between the first OTDOA and the second OTDOA), which may be used with the distance (d) between the panels' centers, to determine the beam steering adjustment.

The signaling mechanisms for beam steering adjustment, which are described herein, may provide various beneficial effects and/or advantages. For example, the signaling mechanisms may enable a transmit node to adjust a beam used for communication at an antenna panel of a multi-panel antenna array, such as to improve wireless communication performance, including improving wireless coverage, increasing data rates, and/or achieving more efficient communication based on beamforming. The improved wireless communication performance may be attributable to one or more signaling designs described herein which may provide the transmit node with (1) an indication of a distance between each panel of a multi-panel antenna array to a receive node, (2) an indication of a path loss estimate and a differential signal strength, or (3) an indication of a ΔOTDOA for determining and carrying out a beam steering adjustment.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

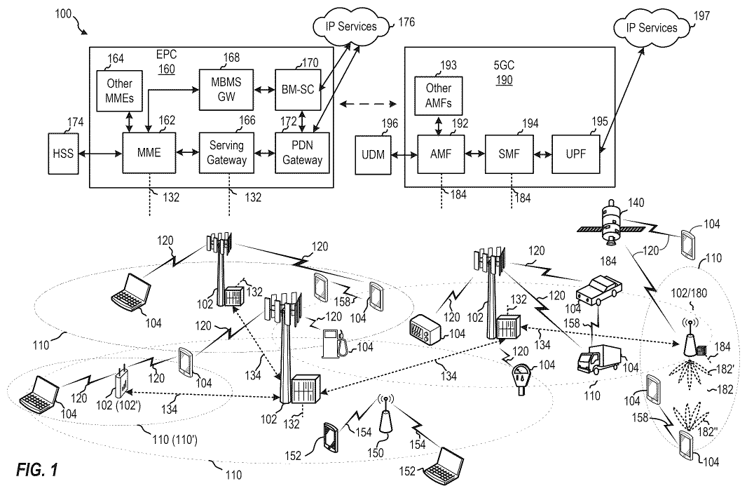

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 11θ′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

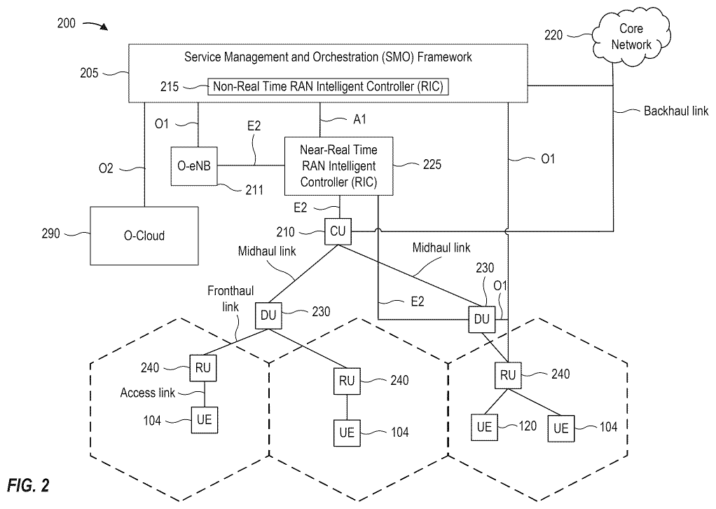

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

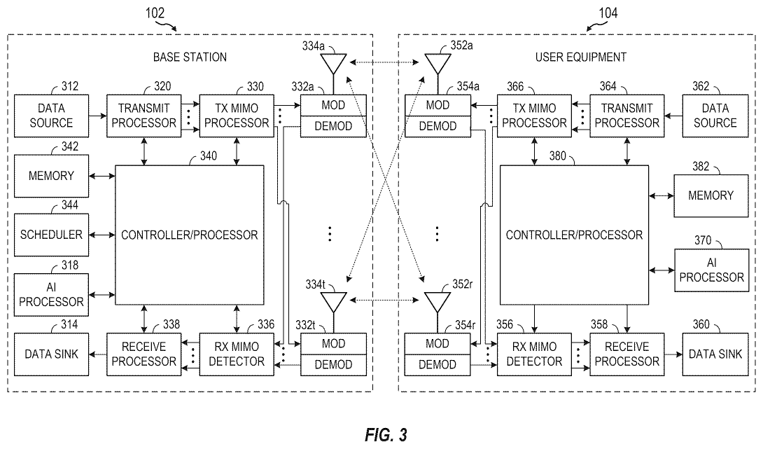

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may transmit and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

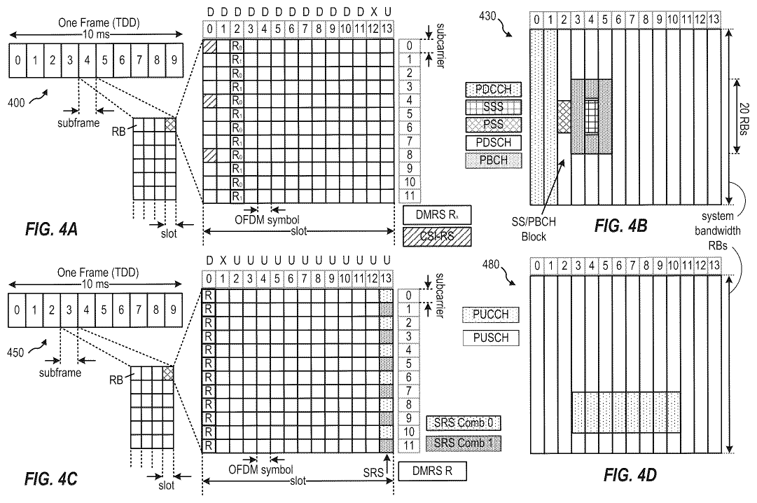

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Multi-Panel Antenna Arrays

An antenna array may include two or more antenna elements that are spatially arranged and electrically interconnected to produce a directional radiation pattern. The antenna elements may include patch antennas, dipole antennas, and/or other types of antennas arranged in a linear pattern, a two-dimensional pattern, or another pattern. A spacing between antenna elements of an antenna array may be such that signals with a desired wavelength transmitted separately by the antenna elements may interact or interfere constructively and destructively along various directions (such as to form a desired beam pattern). For example, by manipulating phase shift, phase offset, and/or amplitude for antenna element(s) of the array, relative to one another, the amplitudes and/or phases of signals transmitted via the antenna elements may be modulated and shifted to generate one or more beams for directional signal transmission or reception (e.g., beamforming). The geometry of the array and the patterns, orientations, and/or polarizations of the antenna elements may influence the performance of the antenna array with respect to beamforming.

In certain aspects, an array may include two or more antenna panels (e.g., multi-panel), where each antenna panel includes a subset of the total antenna elements that make up the antenna array. Such multi-panel designs may be common for large antenna arrays. In some cases, a large antenna array may refer to an antenna array that is larger than or equal in size to a 64×8 antenna array, having 512 antenna elements. An example large antenna array used in Frequency Range 3 (FR3), also known as upper-midband frequencies spanning 7.125 GHz-24.25 GHz, may include 2048 (dual-polarized) antenna elements in a 128×8 configuration.

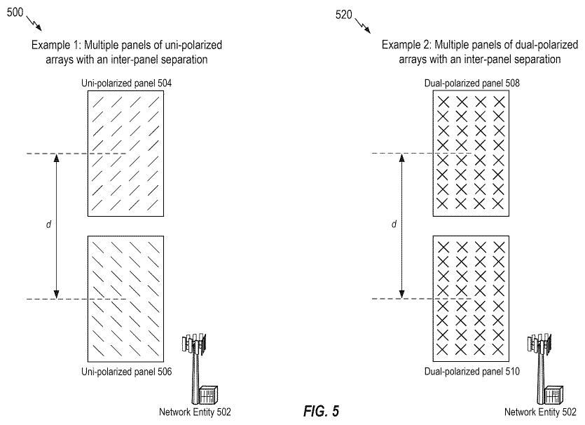

FIG. 5 depicts example multi-panel designs 500, 520 for (e.g., large) antenna arrays. As shown, multi-panel antenna arrays may be designed to include multiple panels. In certain aspects, the multiple panels may include uni-polarized panel(s) with single polarization antenna elements, dual-polarized panel(s) with dual polarization antenna elements, or both. Further, in certain aspects, the multiple panels may be (1) co-located, such that the centers of the panels are aligned, or (2) non-co-located, such that the center of at least a first panel of the antenna array is separated from a center of at least a second panel of the antenna array by a distance.

For example, in a first multi-panel design 500 shown in FIG. 5, an antenna array may include multiple uni-polarized panels (e.g., arrays of single polarization antenna elements), including uni-polarized panel 504 and uni-polarized panel 506. Uni-polarized panel 504 may include antenna elements associated with a first polarization, and uni-polarized panel 506 may include antenna elements associated with a second polarization. For example, uni-polarized panel 504 may include horizontally polarized antenna elements used to transmit and receive horizontally polarized signals, and uni-polarized panel 504 may include vertically polarized antenna elements used to transmit and receive vertically polarized signals (e.g., such as to achieve polarization diversity).

Uni-polarized panel 504 and uni-polarized panel 506 may be associated with an antenna array implemented at a transmit node, such as a network entity 502 (e.g., BS 102 of FIGS. 1 and 3, or a disaggregated base station as discussed with respect to FIG. 2). In some other examples, uni-polarized panel 504 and uni-polarized panel 506 may be associated with an antenna array implemented at a transmit node, such as a UE (e.g., UE 104 of FIGS. 1 and 3) (not shown).

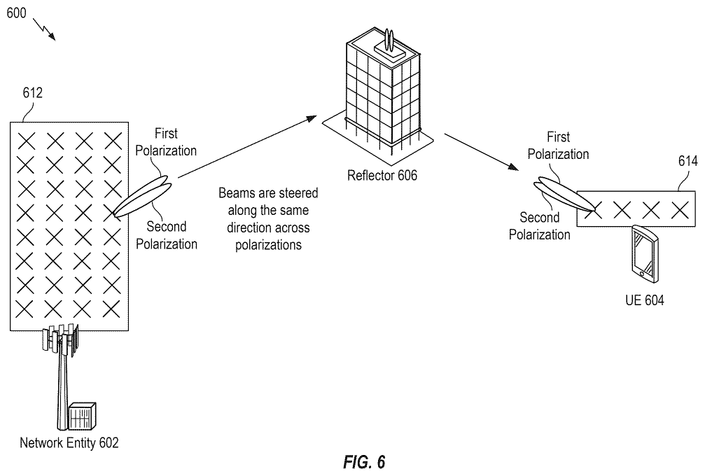

Further, in the first multi-panel design 500, uni-polarized panel 504 and uni-polarized panel 506 may be non-co-located such that they are deployed with inter-panel separation. For example, a center of uni-polarized panel 504 may be separated from uni-polarized panel 506 by a distance (d). In some other example designs, uni-polarized panel 504 and uni-polarized panel 506 may be co-located (e.g., a center of each panel 504, 506 may align). A co-located uni-polarized panel design is depicted and described below with respect to FIG. 6.

In a second multi-panel design 520 shown in FIG. 5, an antenna array may include multiple dual-polarized panels (e.g., arrays of dual polarization antenna elements), including dual-polarized panel 508 and dual-polarized panel 510. For dual-polarized panel 508 and dual-polarized panel 510, electromagnetic waves may be propagated in two orthogonal polarizations, such as horizontally and vertically.

Dual-polarized panel 508 and dual-polarized panel 510 may be associated with an antenna array implemented at a transmit node, such as a network entity 502. In some other examples, dual-polarized panel 508 and dual-polarized panel 510 may be associated with an antenna array implemented at a transmit node, such as a UE (not shown).

Further, in the second multi-panel design 520, dual-polarized panel 508 and dual-polarized panel 510 may be non-co-located such that they are deployed with inter-panel separation. For example, a center of dual-polarized panel 508 may be separated from dual-polarized panel 510 by a distance (d). In some other example designs, dual-polarized panel 508 and dual-polarized panel 510 may be co-located (e.g., a center of each panel 508, 510 may align).

FIG. 6 depicts example transmissions using antenna arrays with co-located uni-polarized panels. As shown, an antenna array 612 may include multiple antenna elements, which belong to two different uni-polarized panels (e.g., which are shown as overlapping in the figure to create antenna array 612). Antenna array 612 may be implemented at a transmit node, such as a network entity 602, to communicate with a receive node, such as UE 604. For example, a first uni-polarized panel of antenna array 612 may include antenna elements associated with a first polarization (e.g., horizontally polarized antenna elements) used to transmit, from network entity 602 to UE 604, polarized signals in a first direction (e.g., horizontally). Further, a second uni-polarized panel of antenna array 612 may include antenna elements associated with a second polarization (e.g., vertically polarized antenna elements) used to transmit, from network entity 602 to/from UE 604, polarized signals in a second direction (e.g., vertically).

The uni-polarized panels of antenna array 612 may be co-located, such that a center of each uni-polarized panel coincide. Accordingly, when transmitting signals using the uni-polarized panels, a first wireless signal transmitted according to the first polarization of the first uni-polarized panel and a second wireless signal transmitted according to the second polarization may be transmitted along a same direction. Put differently, a common beam may be used to steer the wireless signal from the first uni-polarized panel and the wireless signal from the second uni-polarized panel, which may result in both signals being beamformed in a single direction from network entity 602.

The wireless signals may be sent to UE 604 via a reflector 606. For example, reflector 606 may be used to redirect (and in some cases amplify via an amplifier) signals from network entity 602 towards UE 604.

An antenna array 614 may be implemented at UE 604 to enable UE 604 to receive signal(s) from network entity 602. Antenna array 614, may also include multiple antenna elements, which may belong to two different uni-polarized panels (e.g., which are shown as overlapping in the figure to create antenna array 614). A first uni-polarized panel of antenna array 614 may include antenna elements associated with a first polarization (e.g., horizontally polarized antenna elements) used to receive, at UE 604 from network entity 602, polarized signals in a first direction (e.g., horizontally). Further, a second uni-polarized panel of antenna array 614 may include antenna elements associated with a second polarization (e.g., vertically polarized antenna elements) used to receive, at UE 604 from network entity 602, polarized signals in a second direction (e.g., vertically).

The uni-polarized panels of antenna array 614 may be co-located, such that a center of each uni-polarized panel coincide with one another. Accordingly, when receiving signals using the uni-polarized panels, a first wireless signal may be received at each panel using a common beam, e.g., associated with a same direction. Put differently, the wireless signals may be received at UE 604 along a same direction over both polarizations.

For dual-polarized transmissions when using (1) a single dual-polarized panel or (2) two uni-polarized panels, a single TCI state may be assumed to be common across both polarizations and used to (1) determine a common beam over the two polarization layers or (2) determine a beam for one polarization layer, which may then also be used for the other polarization layer (e.g., the beam may be derived from one polarization for the other polarization). Accordingly, transmissions of signals according to a first and second polarization may be sent in a same direction, using the same beam. Dual-polarized transmissions (1) sent from a single panel antenna array (e.g., with dual polarization antenna elements), (2) sent from co-located uni-polarized panels of an antenna array (e.g., as shown in FIG. 5), and/or (3) sent from non-co-located uni-polarized panels of an antenna array separated by a small distance (d) (e.g., between their centers) (e.g., when the antenna array is a small antenna array), using a common beam may be sent in a same direction, effectively forming a beamformed signal directed to a receive node. Dual-polarized transmissions sent from non-co-located uni-polarized panels of an antenna array separated by a larger distance, such as when the panels form a large antenna array, using a common beam may be sent in different directions, however. Thus, a beamformed signal from the antenna array may not be formed. Similarly, when using non-co-located uni-polarized panels for reception, signals may be received along different directions over both polarizations.

FIG. 7 depicts the example discrepancy in directions of transmissions from two non-co-located antenna panels of an antenna array. As shown in FIG. 7, an example antenna array implemented at a transmit node, in this example, a network entity 702, may include two uni-polarized panels 712, 716. Uni-polarized panel 712 may include antenna elements associated with a first polarization, and uni-polarized panel 716 may include antenna elements associated with a second polarization. For example, uni-polarized panel 712 may include horizontally polarized antenna elements used to transmit and receive horizontally polarized signals, and uni-polarized panel 716 may include vertically polarized antenna elements used to transmit and receive vertically polarized signals.

Uni-polarized panel 712 and uni-polarized panel 716 may be non-co-located (e.g., their centers may not coincide). Accordingly, a center of uni-polarized panel 712 may be separated from uni-polarized panel 716 by a distance (d).

Uni-polarized panel 712 and uni-polarized panel 716 may be used to transmit beamformed signals to a receive node (not shown), such as via reflector 706. A beam used to transmit a signal from uni-polarized panel 712 and uni-polarized panel 716 may be based on a same TCI state (e.g., a TCI state may be assumed common across both polarizations). Accordingly, a same beam may be selected for beamforming signals from uni-polarized panel 712 and uni-polarized panel 716.

Due to the distance (d) separating uni-polarized panels 712, 716, however, use of a common beam may not be feasible. For example, different beams, corresponding to different transmission directions/beam steering angles, may need to be used to cause signals sent from both uni-polarized panels 712, 716 to reach reflector 706.

Specifically, as shown, a first beam associated with a first direction (e.g., beam steering angle θ) may be used to transmit a first wireless signal from uni-polarized panel 712, and a second beam associated with a second direction (e.g., beam steering angle θ′) may be used to transmit a second wireless signal from uni-polarized panel 716. Beam steering angle θ associated with the first beam may be different than beam steering angle θ′ associated with the second beam (e.g., θ≠θ′). The difference in beam steering angles, θ and θ′, may be based on the distance (d) between the centers of uni-polarized panels 712, 716, as well as the distance D from the center of uni-polarized panel 712 to reflector 706 and the distance D′ from the center of uni-polarized panel 716 to reflector 706. For example, the relationship between beam steering angle θ and beam steering angle θ′ may be represented as:

$$sin ( {θ}^{′} ) = \frac{D sin ( θ ) + d}{{D}^{′}}$$

where d represents the distance between the distance between the centers of uni-polarized panels 712, 716, D represents the distance from the center of uni-polarized panel 712 to reflector 706, and D′ represents the distance from the center of uni-polarized panel 716 to reflector 706.

Transmitting the second wireless signal, from uni-polarized panel 716, using the second beam, associated with beam steering angle θ′, instead of the first beam (e.g., associated with beam steering angle θ) used to also transmit the first wireless from uni-polarized panel 712 may allow the second wireless signal to reach reflector 706 (and thus be reflected towards a particular receive node). In cases where a same beam is used across panels 712, 716, such that the second wireless signal is sent from uni-polarized panel 716 using the first beam steering angle θ (e.g., determined based on the common TCI state across the dual polarizations), the second wireless signal may not reach reflector 706, as shown at 708 in FIG. 7.

As the distance of reflector 706 from uni-polarized panels 712, 716 increases, D and D′ may increase to a point where D≈D′, and the difference between beam steering angles θ and θ′ may decrease to a point where θ≈θ′. For example, the distance between the centers of uni-polarized panels 712, 716 may be not be relevant, given the above equation. When D≈D′=D1 and θ≈θ′=θ1, the equation may be written as:

$$\begin{matrix}sin ( {θ}^{′} ) = \frac{D sin ( θ ) + d}{{D}^{′}} \\ sin ( θ1 ) \approx \frac{D 1 sin ( θ1 ) + d}{D 1} \\ sin ( θ1 ) \approx sin ( θ1 ) + \frac{d}{D 1}\end{matrix}$$

where the value of d becomes negligent. As such, some conventional techniques may not need to consider the distance (d) between antenna panel centers when determining a beam steering angle for beamforming when using non-co-located multi-panel antenna arrays.

However, this may not be the case where, for example, large antenna arrays are implemented, including larger size antenna panels that have a distance (d) between their centers. For example, a bottom edge of a first 4×8 antenna panel may be placed adjacent to a top edge of a second 4×8 antenna panel to create a small antenna array. The distance between the centers of these panels may be equal to eight antenna elements. If the size of each of the antenna panels is increased to a 32×8 antenna panel to create a large antenna array, then the distance between the centers of these panels may be equal to 64 antenna elements. Using the above equation, a distance (d) equal to 64 antenna elements may significantly change the beam steering angle θ′, at least with respect to beam steering angle θ. Accordingly, the discrepancy in beam steering angles may need to be considered in beamforming, especially in cases where non-co-located panels of a large antenna array are used for transmitting the beamformed transmissions.

Some conventional approaches attempt to bypass the need for beam steering adjustment by using multiple TCI states across polarizations (instead of assuming that a single TCI is common across polarizations). However, a technical problem associated with this approach includes an increase in feedback overhead associated with indicating the additional TCI states across polarizations for beam selection. Further, this approach may present a technical problem for some polarization-specific beamforming protocol(s).

### Aspects Related to Beam Steering Adjustments for Multi-Panel Antenna Arrays

Aspects of the present disclosure provide techniques for beam steering adjustments for multi-panel antenna arrays. For example, a (e.g., large) multi-panel antenna array may be implemented at a transmit node. The multi-panel antenna array may include two antenna panels, each having multiple antenna elements for transmitting beamformed radio signal(s) to a receive node. The panels may be non-co-located such that the centers of the two antenna panels are separated by a distance (d). Accordingly, a same beam used for transmission of a wireless signal from each of the panels may result in the signals being sent in different directions (e.g., although intended for the same receive node). To instead beamform the signals in a same direction (e.g., towards a receive node), a beam for at least one of the panels may be adjusted, where the adjustment is based on at least the distance (d) between the centers of the panels. Put differently, instead of using a same beam steering angle θ for transmission of a wireless signal from each of the panels, the beam steering angle θ may be used for transmission of a wireless signal from the first panel and a beam steering angle θ′ may be used for transmission of a wireless signal from the second panel (e.g., where beam steering angles θ and θ′ may be different). As described herein, the term “beam” may refer to a directional transmission of a wireless signal towards a receive node; thus, “adjusting” a beam for at least one of the panels of the antenna array may refer to adjusting a directional transmission of a wireless signal sent from at least one panel, or more specifically, adjusting a beam steering angle (e.g., θ′) of the wireless signal.

Aspects herein provide signaling designs used to provide the transmit node with information to enable such beam steering adjustment for one of the panels, or more specifically, determine the beam steering angle θ′ to communicate wireless signal(s) from the second panel (e.g., while a beam steering angle θ is used to communicate wireless signal(s) from the first panel). For example, in a first signaling design, the transmit node may be provided with an explicit indication of the distance between each of the panels and the receive node, which the transmit node may use to determine the beam steering angle θ′(e.g., in addition to the distance (d) between the centers of the panels). In a second signaling design, the transmit node may be provided with an indication of a path loss estimate and a differential signal strength, which the transmit node may use to determine the beam steering angle θ′ (e.g., in addition to the distance (d) between the centers of the panels). In a third signaling design, the transmit node may be provided with indications of OTDOAs, associated with each of the panels, for determining the beam steering angle θ′ (e.g., in addition to the distance (d) between the centers of the panels). The transmit node may use the beam steering angle θ′ to steer a beam from the second panel (e.g., instead of beam steering angle θ) to help improve beamforming of wireless signals at the transmit node.

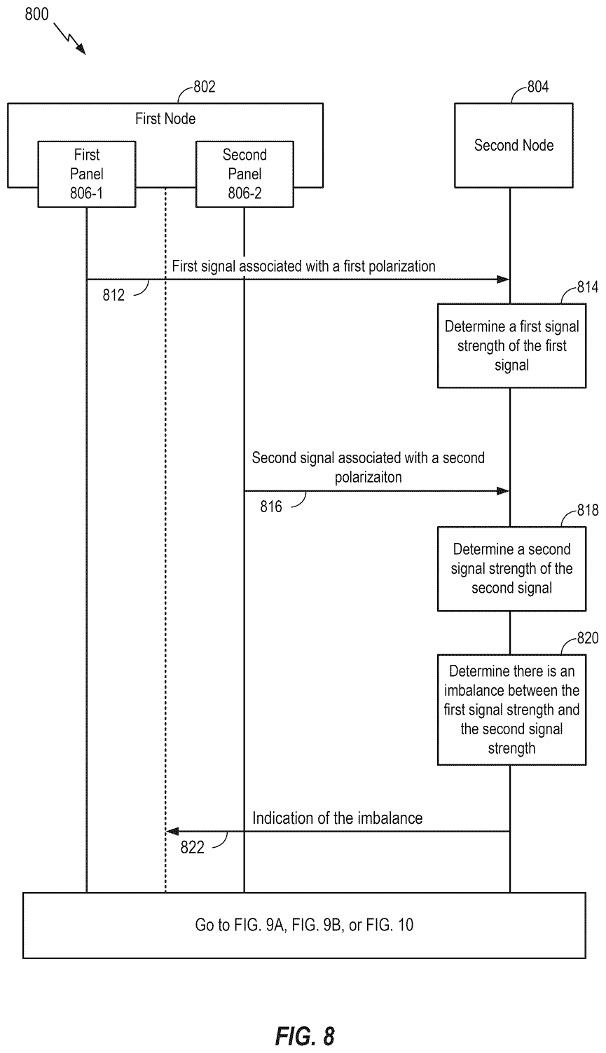

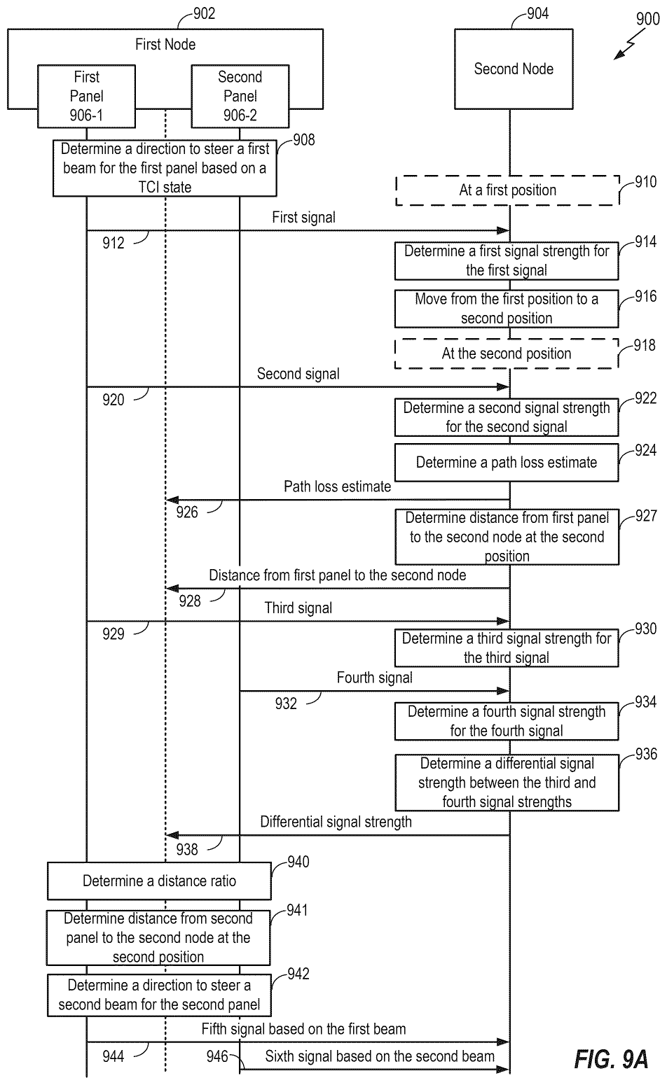

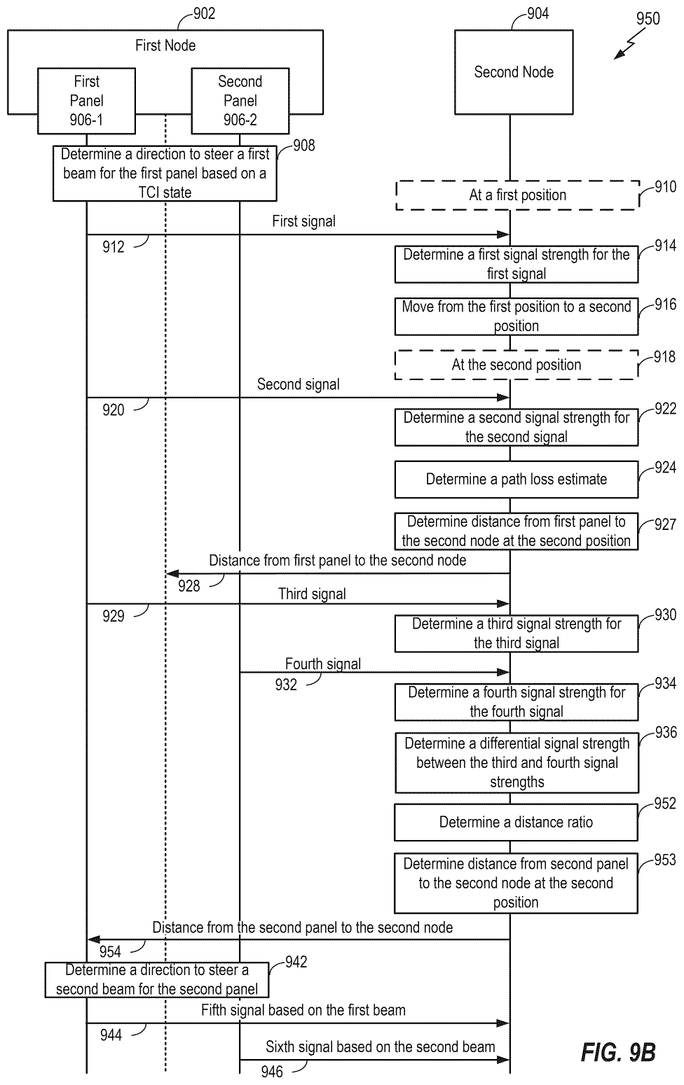

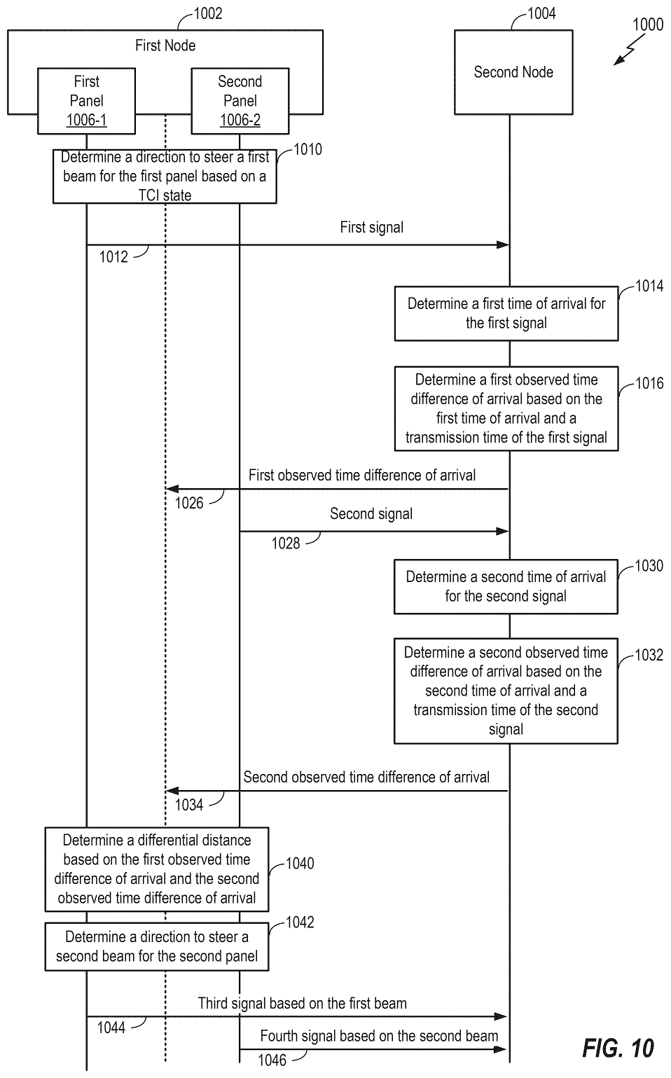

Each of these signaling mechanisms are described in detail below with respect to FIGS. 9A, 9B, and 10. In certain aspects, the signaling described in FIGS. 9A, 9B, and 10 for beam steering adjustment may need to be triggered. FIG. 8 provides example signaling that may trigger the beam steering adjustment processes outlined in FIGS. 9A, 9B, and 10.

### Example Signaling to Trigger Beam Steering Adjustments

FIG. 8 depicts a process flow 800 for communications in a network between a first node 802 and a second node 804. In certain aspects, first node 802 is a transmit node, and second node 804 is a receive node. In certain aspects, the transmit node or the receive node may be a network entity. The network entity may be an example of the BS 102 depicted and described with respect to FIGS. 1 and 3 or a disaggregated base station depicted and described with respect to FIG. 2. In certain aspects, the transmit node and/or the receive node may be a UE. The UE may be an example of UE 104 depicted and described with respect to FIGS. 1 and 3. However, in other aspects, the first node 802 may be another type of wireless communications device, network entity, or network node, such as those described herein. Similarly, the second node 804 may be another type of wireless communications device, network entity, or network node, such as those described herein. Note that any operations or signaling illustrated with dashed lines may indicate that that operation or signaling is an optional or alternative example.

In certain aspects, first node 802 includes a first panel 806-1 and a second panel 806-2. First panel 806-1 and second panel 806-2 may each be an example of an antenna panel including multiple antenna elements (not shown) for communicating with, at least, second node 804. In certain aspects, first panel 806-1 and second panel 806-2 may each be a uni-polarized antenna panel (e.g., similar to multi-panel design 500 depicted and described with respect to FIG. 5). In certain aspects, first panel 806-1 and second panel 806-2 may each be a dual-polarized antenna panel (e.g., similar to multi-panel design 520 depicted and described with respect to FIG. 5).

In certain aspects, first panel 806-1 and second panel 806-2 may be non-co-located, such that the centers of first panel 806-1 and second panel 806-2 are not aligned. Put differently, a center of first panel 806-1 may be separated from a center of second panel 806-2 by a distance (d).

Process flow 800 begins, at block 812, with first node 802 transmitting, to second node 804, a first signal according to a first polarization. For example, first node 802 may transmit the first signal via first panel 806-1 associated with the first polarization.

At block 814, second node 804 determines a first signal strength of the first signal. For example, second node 804 may determine a first reference signal reference power (RSRP) associated with the first signal.

At block 816, first node 802 transmits, to second node 804, a second signal according to a second polarization. For example, first node 802 may transmit the second signal via second panel 806-2 associated with the second polarization.

At block 818, second node 804 determines a second signal strength of the second signal. For example, second node 804 may determine second RSRP associated with the second signal.

At block 820, second node 804 determines that there is an imbalance between the first signal strength (e.g., determined at block 814) and the second signal strength (e.g., determined at block 818). For example second node 804 may determine that a difference between the first signal strength and the second strength satisfies a threshold (e.g., |First RSRP−Second RSRP|>Threshold).

At block 822, second node 804 transmits an indication of the imbalance between the first signal strength and the second signal strength. In certain aspects, transmitting the indication of the imbalance may trigger a method for beam steering adjustment. For example, signaling in in FIG. 9A, 9B, or 10 may be carried out to adjust the beam steering angle of wireless signals sent from a second panel 906-2 or 1006-2, which is an example of second panel 806-2 in FIG. 8.

Note that the process flow illustrated in FIG. 8 is described herein to facilitate an understanding of a process for triggering beam steering adjustment, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Signaling for Carrying Out Beam Steering Adjustments

FIGS. 9A-9B depict process flows 900, 950 for communications in a network between a first node 902 and a second node 904.

In certain aspects, first node 902 may be an example of first node 802 in FIG. 8. For example first node 902 may include a first panel 906-1 and a second panel 906-2, which are similar to first panel 806-1 and second panel 806-2, depicted and described with respect to FIG. 8. Further, in certain aspects, second node 904 may be an example of second node 804 in FIG. 8.

Process flows 900, 950 may be used to adjust a beam steering angle (θ′) for second panel 906-2. For example, the beam steering angle (θ′) may be adjusted based on a distance (d) between the center of first panel 906-1 and the center of second panel 906-2, as well as a distance (D) from the center of the first panel 906-1 to second node 904 (e.g., also referred to herein as d₂ when second node 904 is at a second position) and a distance (D′) from the center of the second panel 906-2 to second node 904 (e.g., also referred to herein as d₃ when second node 904 is at the second position). Although, FIGS. 9A and 9B describe distances D and D′ being measured from a center of each of first panel 906-1 and second panel 906-2, respectively, in certain aspects, the distances D and D′ may be measured from another point on each of first panel 906-1 and second panel 906-2, respectively. In process flow 900 of FIG. 9A, the distance D′ (as well as a distance ratio of

$$\frac{{D}^{′}}{D} )$$

may be determined by first node 902, while in process flow 950 of FIG. 9B, the distance D′ (as well as a distance ratio of

$$\frac{{D}^{′}}{D} )$$

may be determined by second node 904.

Process flow 900 begins, at block 908, with first node 902 determining a direction to steer a first beam from the first panel 906-1 based on a TCI state associated with the polarization of the first panel 906-1. For example, at block 908, first node 902 may determine a beam steering angle θ (e.g., a first beam).

At 912, first node 902 transmits, to second node 904, a first signal via first panel 906-1. For example, the first signal may be one signal in a set of reference signals (e.g., pathlossRSs) used to enable the second node 904 to estimate a path loss as second node 904 changes positions. The first signal may be sent to second node 904 when second node 904 is at a first position (e.g., as shown at block 910). When second node 904 is at the first position, a distance between a center of the first panel 906-1 and the second node 904 may be equal to d₁.

At block 914, second node 904 determines a first signal strength of the first signal. For example, second node 904 may determine a first RSRP for the first signal.

At block 916, second node 904 moves from the first position to a second position. Thus, at block 918, second node 904 may be at a second position different than the first position. When second node 904 is at the second position, a distance between a center of the first panel 906-1 and the second node 904 may be equal to d₂.

At 920, first node 902 transmits, to second node 904, a second signal via first panel 906-1 (e.g., the same panel used to transmit the first signal). For example, the second signal may be another signal in a set of reference signals (e.g., pathlossRSs) used to enable second node 904 to estimate the path loss as second node 904 changes positions. The second signal may be sent to second node 904 when second node 904 is at the second position.

At block 922, second node 904 determines a second signal strength of the second signal. For example, second node 904 may determine a second RSRP for the second signal.

At block 924, second node 904 determines a path loss estimate (PLE) (also referred to herein as path loss exponent (PLE)) based on the first signal strength (e.g., determined at block 914) and the second signal strength (e.g., determined at block 922). For example, second node 904 may compute the path loss estimate (PLE) using the following equation:

$$Δ RSRP = 10 * PLE * {log}_{10} ( \frac{{d}_{2}}{{d}_{1}} )$$

where ΔRSRP represents the differential signal strength (in dB scale) between the first signal strength and the second signal strength (e.g., differential signal strength=10 log₁₀(|first signal strength−second signal strength|)), d₂ represents the distance from the center of first panel 906-1 to second node 904 when second node 904 is at the second position, and d₁ represents the distance from the center of first panel 906-1 to second node 904 when second node 904 is at the first position. Here, distance ratio,

$$\frac{{d}_{2}}{{{d}_{1}}^{′}}$$

may be known by second node 904. For example, the transition of second node 904 from the first position to the second position (e.g., at block 918) may be a deterministic move aimed at estimating PLE. Thus, second node 904 may know the distance it has moved from the first position to the second position, such that distance ratio,

$$\frac{{d}_{2}}{{d}_{1}} ,$$

in the equation above is known by second node 904.

Specific to FIG. 9A, at 926, second node 904 transmits, to first node 902, the path loss estimate (PLE).

At block 927, second node 904 determines the distance, d₂ (e.g., also referred to herein as variable D), from the center of first panel 906-1 to second node 904 when second node 904 is at the second position. For example, second node may determine the distance d₂ using the following equation:

$$PL ( {d}_{2} ) [ in dB ] = 20 {log}_{10} ( \frac{4 π {d}_{0}}{λ} ) + 10 \cdot PLE \cdot {log}_{10} ( \frac{{d}_{2}}{{d}_{0}} )$$

where:

$$PL ( {d}_{2} ) [ in dB ] = ( Transmit power for the second signal ) - ( Second signal strength for the second signal )$$

and where d₂ represents the distance from the center of first panel 906-1 to second node 904 when second node 904 is at the second position, PL(d₂) represents the path loss along d₂, “transmit power for the second signal” represents the transmit power of the second signal sent from first panel 906-1 to second node 904 at 920, and “second signal strength for the second signal” represents the second signal strength determined at block 922. In certain aspects, the transmit power of the second signal sent from the first panel 906-1 to second node 904 is signaled to second node 904. Further, d₀ may generally be set to 1m, and

$$( \frac{4 π {d}_{0}}{λ} )$$

may represent a deterministic number based on the carrier frequency. Lastly, PLE may represent the path loss estimate determined at block 924. Thus, the above equation may be used to solve for d₂, or more specifically the distance from the center of first panel 906-1 to second node 904 when second node 904 is at the second position.

Specific to FIG. 9A, at 928, second node 904 transmits, to first node 902, an indication of the distance, d₂, from the center of first panel 906-1 to second node 904 when second node 904 is at the second position.

At 929, first node 902 transmits, to second node 904, a third signal via first panel 906-1. For example, the third signal may be one signal in another set of reference signals used to enable second node 904 to determine a differential signal strength. The set of reference signals may be configured as nrofReportedRS in CSI-ReportConfig with a parameter greater than one.

The third signal, from first panel 906-1, may be sent to second node 904 when second node 904 is at the second position (e.g., shown at block 918). When second node 904 is at the second position, a distance between a center of the first panel 906-1 and the second node 904 may be equal to d₂.

At block 930, second node 904 determines a third signal strength of the third signal. For example, second node 904 may determine a third RSRP for the third signal.

At 932, first node 902 transmits, to second node 904, a fourth signal via second panel 906-2 (e.g., a different panel than the panel used to transmit the third signal). For example, the fourth signal may be another signal in the other set of reference signals used to enable second node 904 to determine the differential signal strength.

The fourth signal, from panel 906-2, may be sent to second node 904 when second node 904 is at the second position (e.g., shown at block 918). When second node 904 is at the second position, a distance between a center of the second panel 906-2 and the second node 904 may be equal to d₃.

At block 934, second node 904 determines a fourth signal strength of the fourth signal. For example, second node 904 may determine a fourth RSRP for the fourth signal.

At blocks 936 and 938, second node 904 determines a differential signal strength (e.g., ΔRSRP in dB scale) between the third signal strength and the fourth signal strength, and transmits an indication of the differential signal strength to first node 902.

At block 940, first node 902, determines a distance ratio

$$( \frac{{d}_{3}}{{d}_{2}} )$$

of the distance (d₃) between the center of the second panel 906-2 to second node 904 to the distance (d₂) between the center of the first panel 906-1 to second node 904. For example, first node 902 may determine distance ratio

$$( \frac{{d}_{3}}{{d}_{2}} )$$

using the following equation:

$$Δ R S R P = 10 * P LE * {log}_{10} ( \frac{{d}_{3}}{{d}_{2}} )$$

where d₃ represents the distance from the center of second panel 906-2 to second node 904 when second node 904 is at the second position, d₂ represents the distance from the center of first panel 906-1 to second node 904 when second node 904 is at the second position, ΔRSRP represents the differential signal strength between the third signal strength and the fourth signal strength (e.g., differential signal strength=|third signal strength−fourth signal strength|), which was indicated to first node 902 at 938, and PLE represents the path loss estimate which was indicated to first node 902 at block 926. Distance d₂ may be known by second node 904.

At block 941, first node 902 uses the distance ratio

$$( \frac{{d}_{3}}{{d}_{2}} )$$

(e.g., determined at block 940) and the distance, d₂, from the center of first panel 906-1 to second node 904 when second node 904 is at the second position (e.g., indicated to first node 902 at 928) to determine the distance, d₃, from the center of first panel 906-1 to second node 904 when second node 904 is at the second position (e.g., also referred to herein as variable D′).

In certain aspects, distance d₃ (e.g., determined at block 941), distance d₂ from the center of first panel 906-1 to second node 904 when second node 904 is at the second position (e.g., indicated to first node 902 at 928), and the distance d separating the center of first panel 906-1 and a center of second panel 906-2 may then be used to determine a direction to steer a second beam for second panel 906-2 For example, at block 942, first node 902 determines the beam steering angle θ′ (e.g., the second beam) for transmitting a signal. First node 902 may determine the beam steering angle θ′ (e.g., the second beam) using the following equation:

$${θ}^{′} = {sin}^{- 1} ( sin ( θ ) + δ )$$

$$where$$

$$δ = \frac{D - {D}^{′}}{{D}^{′}} \cdot sin ( θ ) + \frac{d}{{D}^{′}}$$

or rewritten as

$$sin ( {θ}^{′} ) = \frac{D sin ( θ ) + d}{{D}^{′}}$$

where D′ equals d₃ (e.g., the distance from the center of second panel 906-2 to second node 904 when second node 904 is at the second position), D equals d₂ (e.g., the distance from the center of first panel 906-1 to second node 904 when second node 904 is at the first position), θ represents the beam steering angle associated with first panel 906-1 (e.g., determined at block 908), and d represents the distance between the center of first panel 906-1 and the center of second panel 906-2. The beam steering angle θ′ (e.g., the second beam) may be determined to be different than the beam steering angle θ (e.g., the first beam). In certain aspects, the beam steering angle θ′ and/or the beam steering angle θ may be in azimuth alone, in elevation alone, or in both azimuth and elevation.

At block 944, first node 902 transmits a fifth signal based on the first beam, or the beam steering angle θ. At block 946, first node 902 transmits a sixth signal based on the second beam, or the beam steering angle θ′. Put differently, first node 902 uses the parallax-modified steered beam for first panel 906-1 and second panel 906-2, along θ and θ′ respectively, in downlink communications with second node 904 (e.g., here, parallax refers to the error caused by relative distance changes from first panel 906-1 to second panel 906-2). In certain aspects, this parallax-modified beamforming may be used for coherently combining signals across first panel 906-1 and second panel 906-2 (and/or other panels). Further, in certain aspects, this parallax-modified beamforming may be used for dual-polarized communication with different directed/steered beams from first panel 906-1 and second panel 906-2. In certain aspects, this parallax-modified beamforming may be used for positioning estimates (e.g., BS-assisted or UE-assisted positioning estimates). For example, first node 902 may use the parallax-modified steered beam to make a positioning estimate.

As described above, FIG. 9B is similar to FIG. 9A; however, in process flow 950 of FIG. 9B, the distance, d₃ (also referred to herein as variable D′) from the center of second panel 906-2 to second node 904, when second node 904 is at the second position, may be determined by second node 904 and reported to first node 902 (e.g., instead of first node 902 determining this distance). Further, in process flow 950 of FIG. 9B, second node 904, instead of first node 902, may determine the distance ratio

$$( \frac{{d}_{3}}{{d}_{2}} ) .$$

For example, steps at 908-924 in FIG. 9B may be similar to steps at 908-924 in FIG. 9A. After block 924, however, the second node 904 may not transmit an indication of the path loss estimate to first node 902. Steps at block 928-936 in FIG. 9B may also be similar to steps at blocks 928-936 in FIG. 9B. After block 936, however, the second node 904 may not transmit an indication of the differential signal strength to first node 902.

Instead, at block 952, second node 904 determines a distance ratio

$$( \frac{{d}_{3}}{{d}_{2}} )$$

of the distance (d₃) between the center of the second panel 906-2 to second node 904 to the distance (d₂) between the center of the first panel 906-1 to second node 904.

At block 953, second node 904 uses the distance ratio

$$( \frac{{d}_{3}}{{d}_{2}} )$$

(e.g., determined at block 952) and the distance d₂ from the center of first panel 906-1 to second node 904 when second node 904 is at the second position (e.g., determined at block 927) to determine the distance d₃ from the center of first panel 906-1 to second node 904 when second node 904 is at the second position (e.g., also referred to herein as variable D′),

At 954, second node 904 transmits, to first node 902, an indication of the distance d₃ from the center of second panel 906-2 to second node 904 when second node 904 is at the second position. First node 902 may then use distance d₃ (e.g., indicated to first node 902 at 954), distance d₂ from the center of first panel 906-1 to second node 904 when second node 904 is at the second position (e.g., indicated to first node 902 at 928), and the distance d between the center of first panel 906-1 and the center of second panel 906-2 to perform steps at 942-946, which are similar to steps at 942-946 in FIG. 9A.

FIG. 10 depicts a process flow 1000 for communications in a network between a first node 1002 and a second node 1004.

In certain aspects, first node 1002 may be an example of first node 802 in FIG. 8. For example first node 1002 may include a first panel 1006-1 and a second panel 1006-2, which are similar to first panel 806-1 and second panel 806-2, depicted and described with respect to FIG. 8. Further, in certain aspects, second node 1004 may be an example of second node 804 in FIG. 8.

Process flow 1000 may be used to adjust a beam steering angle (θ′) for second panel 1006-2. For example, the beam steering angle (θ′) may be adjusted based on a distance (d) determined between the center of first panel 1006-1 and the center of second panel 1006-2, as well as a difference in OTDOAs (e.g., ΔOTDOA) reported by the second node 1004, such as for each of first panel 1006-1 and second panel 1006-2.

For example, process flow 1000 begins, at block 1010, with first node 1002 determining a direction to steer a first beam from the first panel 1006-1 based on a TCI state associated with the polarization of the first panel 1006-1. For example, at block 1008, first node 1002 may determine a beam steering angle θ (e.g., a first beam) based on the TCI state.

At 1012, first node 1002 transmits, to second node 1004, a first signal via first panel 1006-1. At block 1014, second node 1004 determines a first time of arrival (TOA) for the first signal. The first TOA may represent the absolute time instant when the first signal reaches first node 1002. At block 1016, second node 1004 determines a first OTDOA based on the first TOA and a time of transmission (also referred to herein as a “transmission time”) when the first signal was sent to second node 1004 via the first panel 1006-1. For example, second node 1004 may determine the first OTDOA based on the equation:

$$First OTDOA = \vert ( First TOA ) - ( Transmission Time for the first signal ) \vert$$

In certain aspects, the transmission time for the first signal is known at second node 1004. For example, second node 1004 may receive signaling indicating which signals (e.g., reference signals) are going to be used for timing calculations. This information may indicate an absolute time instance when the first signal is to be sent from first panel 1006-1 to second node 1004. This signaling is not shown in FIG. 10.

At 1026, second node 1004 transmits, to first node 1002, an indication of the first OTDOA.

Further, at 1028, first node 1002 transmits, to second node 1004, a second signal via second panel 1006-2. At block 1030, second node 1004 determines a second TOA for the second signal. The second TOA may represent the absolute time instant when the second signal reaches second node 1004. At block 1032, second node 1004 determines a second OTDOA based on the second TOA and a time of transmission (also referred to herein as a “transmission time”) when the second signal was sent to second node 1004 via the second panel 1006-2. For example, second node 1004 may determine the second OTDOA based on the equation:

$$Second OTDOA = \vert ( Second TOA ) - ( Transmission Time for the second signal ) \vert$$

In certain aspects, the transmission time for the second signal is known at second node 1004. For example, second node 1004 may receive signaling indicating which signals (e.g., reference signals) are going to be used for timing calculations. This information may indicate an absolute time instance when the second signal is to be sent from second panel 1006-2 to second node 1004. This signaling is not shown in FIG. 10.

At 1034, second node 1004 transmits, to first node 1002, an indication of the second OTDOA.

At block 1040, first node 1002, determines the difference between the first OTDOA and the second OTDOA (e.g., ΔOTDOA), given by the equation:

$$Δ OTDOA = \vert ( First OTDOA ) - ( Second OTDOA ) \vert$$

At block 1042, first node 1002 determines a direction to steer a second beam for second panel 1006-2. For example, at block 1042, first node 1002 determines the beam steering angle θ′ (e.g., the second beam). First node 1002 may determine the beam steering angle θ′(e.g., the second beam) based on geometry. For example, first node 1002 may deterministically calculate the beam steering angle θ′ using the ΔOTDOA, the distance d between the center of first panel 906-1 and a center of second panel 906-2, and the speed of light. In certain aspects, the beam steering angle θ′ (e.g., the second beam) may be determined to be different than the beam steering angle θ (e.g., the first beam). In certain aspects, the beam steering angle θ′ and/or the beam steering angle θ may be in azimuth alone, in elevation alone, or in both azimuth and elevation.

At block 1044, first node 1002 transmits a third signal based on the first beam, or the beam steering angle θ. At block 1034, first node 1002 transmits a fourth signal based on the second beam, or the beam steering angle θ′. Put differently, first node 1002 uses the steered beam determined for first panel 1006-1, along θ, and the parallax-modified steered beam for second panel 1006-2, along θ′, in downlink communications with second node 1004.

### Example Operations of a Receive Node

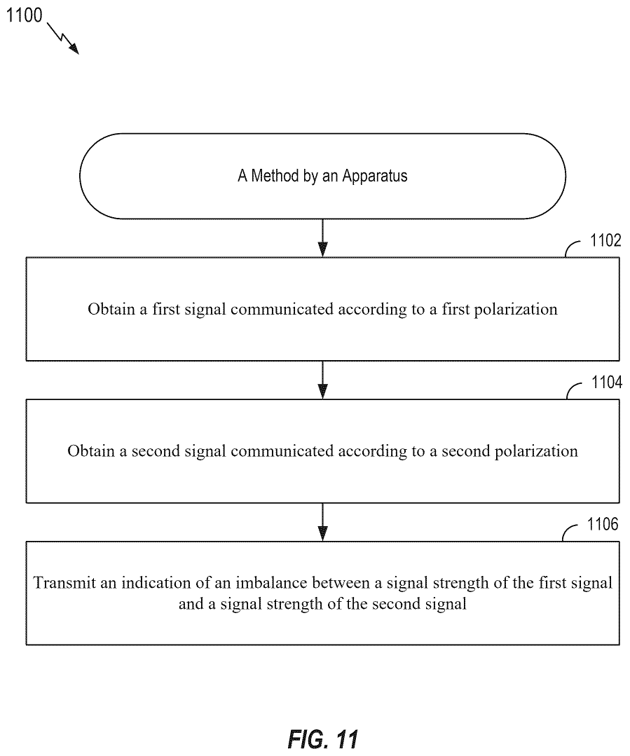

FIG. 11 shows a method 1100 for wireless communications by a receive node. In certain aspects, the receive node is a UE, such as UE 104 of FIGS. 1 and 3. In certain aspects, the receive node is a network entity, such as BS 102 of FIGS. 1 and 3, or a disaggregated base station as discussed with respect to FIG. 2.

Method 1100 begins at block 1102 with obtaining a first signal communicated according to a first polarization.

Method 1100 then proceeds to block 1104 with obtaining a second signal communicated according to a second polarization.

Method 1100 then proceeds to block 1106 with transmitting an indication of an imbalance between a signal strength of the first signal and a signal strength of the second signal.

In one aspect, the indication of the imbalance indicates that a difference between the signal strength of the first signal and the signal strength of the second signal satisfies a threshold.

In one aspect, the first signal is associated with a first antenna panel of a node and the second signal is associated with a second antenna panel of the node.

In one aspect, each of the first antenna panel and the second antenna panel comprises: a uni-polarized array; or a dual-polarized array.

In one aspect, method 1100 further includes obtaining a first reference signal at a first position of the apparatus; obtaining a second reference signal at a second position of the apparatus; obtaining a third reference signal; and obtaining a fourth reference signal.

In one aspect, the first reference signal, the second reference signal, and the third reference signal are associated with a first antenna panel of a node; and the fourth reference signal is associated with a second antenna panel of the node.

In one aspect, method 1100 further includes transmitting an indication of a path loss estimate.

In one aspect, the path loss estimate is based on a signal strength of the first reference signal, a signal strength of the second reference signal, and a distance between the first position and the second position.

In one aspect, method 1100 further includes transmitting an indication of a differential signal strength between a signal strength of the third reference signal and a signal strength of the fourth reference signal.

In one aspect, method 1100 further includes transmitting a first estimated distance between a center of a first antenna panel of a node and the apparatus.

In one aspect, method 1100 further includes transmitting a second estimated distance between a center of a second antenna panel of a node and the apparatus.

In one aspect, the second estimated distance is based on a signal strength of the first reference signal, a signal strength of the second reference signal, a distance between the first position and the second position, a signal strength of the third reference signal, and a signal strength of the fourth reference signal.

In one aspect, method 1100 further includes obtaining a first reference signal; obtaining a second reference signal; and transmitting an indication of a respective observed time difference of arrival associated with each of the first reference signal and the second reference signal.

In one aspect, the first reference signal is associated with a first antenna panel of a node and the second reference signal is associated with a second antenna panel of the node.

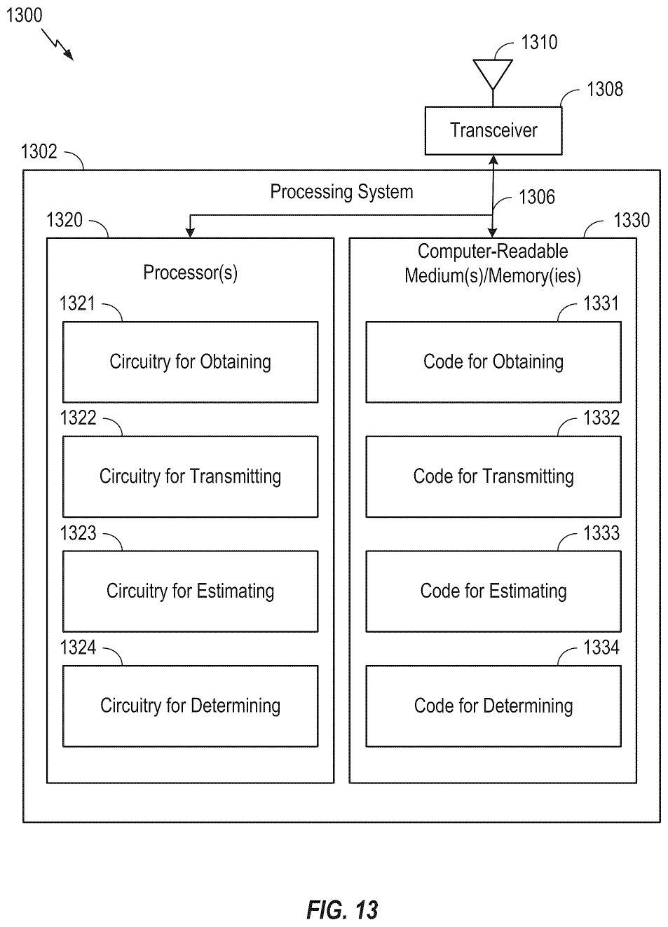

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Operations of a Transmit Node

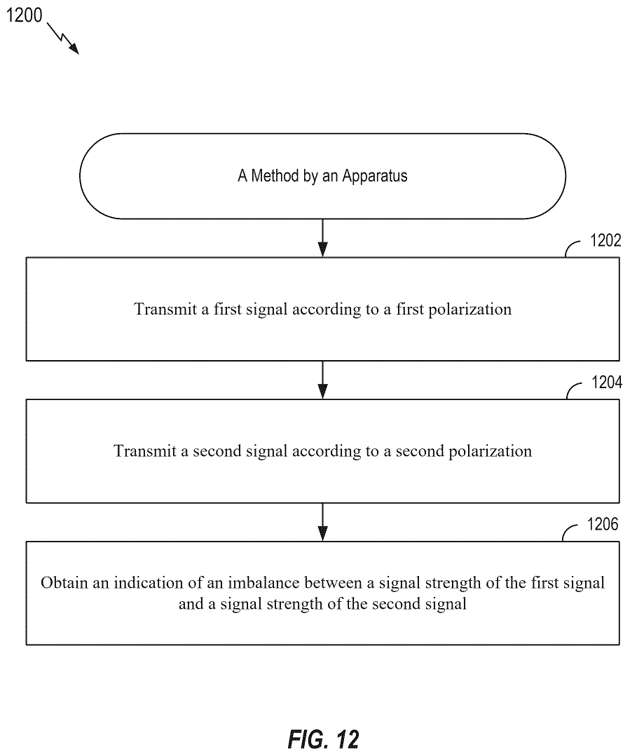

FIG. 12 shows a method 1200 for wireless communications by a transmit node. In certain aspects, the transmit node is a network entity, such as BS 102 of FIGS. 1 and 3, or a disaggregated base station as discussed with respect to FIG. 2. In certain aspects, the transmit node is a UE, such as UE 104 of FIGS. 1 and 3.

Method 1200 begins at block 1202 with transmitting a first signal according to a first polarization.

Method 1200 then proceeds to block 1204 with transmitting a second signal according to a second polarization.

Method 1200 then proceeds to block 1206 with obtaining an indication of an imbalance between a signal strength of the first signal and a signal strength of the second signal.

In one aspect, the indication of the imbalance indicates that a difference between the signal strength of the first signal and the signal strength of the second signal satisfies a threshold.

In one aspect, the first signal is associated with a first antenna panel of the apparatus and the second signal is associated with a second antenna panel of the apparatus.

In one aspect, each of the first antenna panel and the second antenna panel comprises: a uni-polarized antenna array; or a dual-polarized antenna array.

In one aspect, method 1200 further includes transmitting a first reference signal; transmitting a second reference signal; transmitting a third reference signal; and transmitting a fourth reference signal.

In one aspect, the first reference signal, the second reference signal, and the third reference signal are sent from a first antenna panel of the apparatus; and the fourth reference signal is transmitted from a second antenna panel of the apparatus.

In one aspect, method 1200 further includes obtaining, based on transmitting the first reference signal and the second reference signal, an indication of a path loss estimate.

In one aspect, method 1200 further includes obtaining an indication of a differential signal strength between a signal strength of the third reference signal and a signal strength of the fourth reference signal.

In one aspect, method 1200 further comprises: obtaining an indication of a first estimated distance between a center of a first antenna panel of the apparatus and a node; determining a distance ratio of the first estimated distance to a second estimated distance between a center of a second antenna panel of the apparatus and the node based on the path loss estimate and the differential signal strength; determining the second estimated distance based on the first estimated distance and the distance ratio; transmitting a third signal from the first antenna panel of the apparatus according to a first direction, wherein the first direction is based on a transmission configuration indication state; and transmitting a fourth signal from the second antenna panel of the apparatus according to a second direction, wherein the second direction is based on the first estimated distance, the second estimate distance, and a distance between the center of the first antenna panel to the center of the second antenna panel.

In one aspect, method 1200 further comprises obtaining a first estimated distance between a center of a first antenna panel of the apparatus and a node and a second estimated distance between a center of a second antenna panel of the apparatus and the node.

In one aspect, method 1200 further comprises: transmitting a third signal from the first antenna panel of the apparatus according to a first direction, wherein the first direction is based on a transmission configuration indication state; and transmitting a fourth signal from the second antenna panel of the apparatus according to a second direction, wherein the second direction is based on the first estimated distance, the second estimate distance, and a distance between the center of the first antenna panel to the center of the second antenna panel.

In one aspect, method 1200 further comprises: transmitting a first reference signal; transmitting a second reference signal; and obtaining an indication of a respective observed time difference of arrival associated with each of the first reference signal and the second reference signal.

In one aspect, the first reference signal is associated with a first antenna panel of the apparatus and the second reference signal is associated with a second antenna panel of the apparatus.

In one aspect, method 1200 further comprises: determining a difference between the respective observed time difference of arrival associated with the first reference signal and the respective observed time difference of arrival associated with the second reference signal; transmitting a third signal from a first antenna panel according to a first direction, wherein the first direction is based on a transmission configuration indication state; and transmitting a fourth signal from a second antenna panel of the apparatus according to a second direction, wherein the second direction is based on the difference.

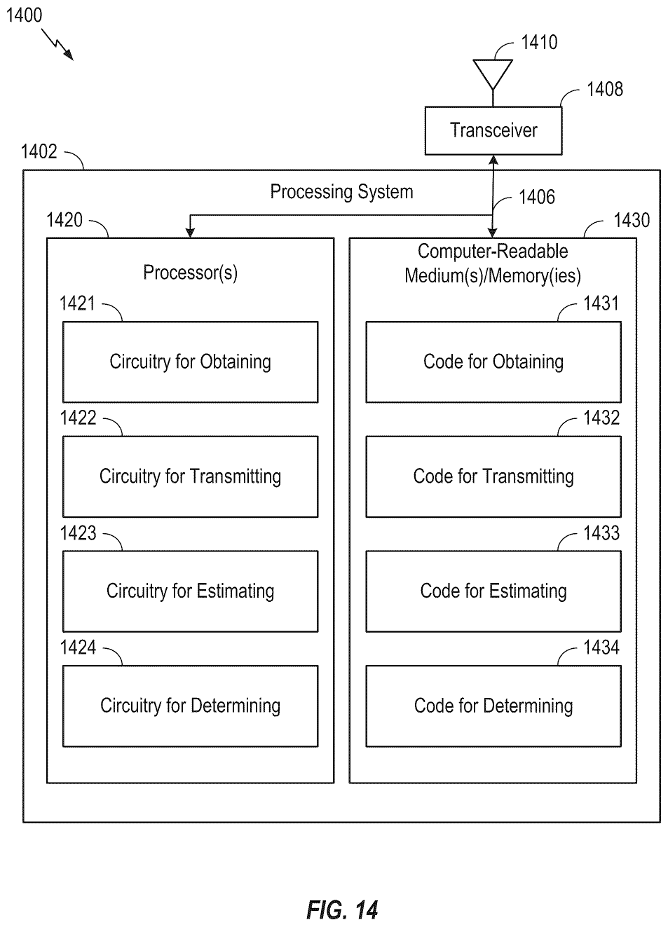

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300. In some aspects, communications device 1300 is a transmit node, such as a user equipment (e.g., such as UE 104 described above with respect to FIGS. 1 and 3) or a network entity (e.g., such as BS 102 of FIGS. 1 and 3, or a disaggregated base station as discussed with respect to FIG. 2).

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 358, transmit processor 364, TX MIMO processor 366, and/or controller/processor 380, as described with respect to FIG. 3. In various other aspects, the one or more processors 1320 may be representative of one or more of receive processor 338, transmit processor 320, TX MIMO processor 330, and/or controller/processor 340, as described with respect to FIG. 3. The one or more processors 1320 are coupled to a computer-readable medium/memory 1330 via a bus 1306. In certain aspects, the computer-readable medium/memory 1330 is configured to store instructions (e.g., computer-executable code) that when executed by the one or more processors 1320, cause the one or more processors 1320 to perform the method 1100 described with respect to FIG. 11, or any aspect related to it, including any operations described in relation to FIGS. 8, 9A, 9B, and 10. Note that reference to a processor performing a function of communications device 1300 may include one or more processors performing that function of communications device 1300, such as in a distributed fashion.

In the depicted example, computer-readable medium/memory 1330 stores code (e.g., executable instructions) for obtaining 1331, code for transmitting 1332, code for estimating 1333, and code for determining 1334. Processing of the code 133-1334 may enable and cause the communications device 1300 to perform the method 1100 described with respect to FIG. 11, or any aspect related to it.

The one or more processors 1320 include circuitry configured to implement (e.g., execute) the code stored in the computer-readable medium/memory 1330, including circuitry for obtaining 1321, circuitry for transmitting 1322, circuitry for estimating 1323, and circuitry for determining 1324. Processing with circuitry 1321-1324 may enable and cause the communications device 1300 to perform the method 1100 described with respect to FIG. 11, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, the transceivers 332, antenna(s) 334, transmit processor 320, TX MIMO processor 330, AI processor 318, and/or controller/processor 340 of the BS 102 illustrated in FIG. 3, transceiver 1308 and/or antenna 1310 of the communications device 1300 in FIG. 13, and/or one or more processors 1320 of the communications device 1300 in FIG. 13. Means for communicating, receiving or obtaining may include the transceivers 354, antenna(s) 352, receive processor 358, AI processor 370, and/or controller/processor 380 of the UE 104 illustrated in FIG. 3, the transceivers 332, antenna(s) 334, receive processor 338, AI processor 318, and/or controller/processor 340 of the BS 102 illustrated in FIG. 3, transceiver 1308 and/or antenna 1310 of the communications device 1300 in FIG. 13, and/or one or more processors 1320 of the communications device 1300 in FIG. 13. In certain aspects, means for estimating and determining of the method 1100 described with respect to FIG. 11, or any aspect related to it, may include controller/processor 340 of the BS 102 illustrated in FIG. 3, controller/processor 380 of the UE 104 illustrated in FIG. 3, and/or one or more processors 1320 of the communications device 1300 in FIG. 13.

FIG. 14 depicts aspects of an example communications device. In some aspects, communications device 1400 is a receive node, such as a network entity (e.g., such as BS 102 of FIGS. 1 and 3, or a disaggregated base station as discussed with respect to FIG. 2) or a user equipment (e.g., such as UE 104 described above with respect to FIGS. 1 and 3).

The communications device 1400 includes a processing system 1402 coupled to a transceiver 1408 (e.g., a transmitter and/or a receiver) and/or a network interface 1412. The transceiver 1408 is configured to transmit and receive signals for the communications device 1400 via an antenna 1410, such as the various signals as described herein. The network interface 1412 is configured to obtain and transmit signals for the communications device 1400 via communications link(s), such as a backhaul link, midhaul link, and/or fronthaul link as described herein, such as with respect to FIG. 2. The processing system 1402 may be configured to perform processing functions for the communications device 1400, including processing signals received and/or to be transmitted by the communications device 1400.

The processing system 1402 includes one or more processors 1420. In various aspects, one or more processors 1420 may be representative of one or more of receive processor 338, transmit processor 320, TX MIMO processor 330, and/or controller/processor 340, as described with respect to FIG. 3. In various other aspects, the one or more processors 1420 may be representative of one or more of receive processor 358, transmit processor 364, TX MIMO processor 366, and/or controller/processor 380, as described with respect to FIG. 3. The one or more processors 1420 are coupled to a computer-readable medium/memory 1430 via a bus 1406. In certain aspects, the computer-readable medium/memory 1430 is configured to store instructions (e.g., computer-executable code), including code aspects 1431-1434, that when executed by the one or more processors 1420, cause the one or more processors 1420 to perform the method 1200 described with respect to FIG. 12, or any aspect related to it, including any operations described in relation to FIGS. 8, 9A, 9B, and 10. Note that reference to a processor of communications device 1400 performing a function may include one or more processors of communications device 1400 performing that function, such as in a distributed fashion.

In the depicted example, the computer-readable medium/memory 1430 stores code (e.g., executable instructions) for obtaining 1431, code for transmitting 1432, code for estimating 1433, and code for determining 1434. Processing of the code 1431-1434 may enable and cause the communications device 1400 to perform the method 1200 described with respect to FIG. 12, or any aspect related to it.

The one or more processors 1420 include circuitry configured to implement (e.g., execute) the code stored in the computer-readable medium/memory 1430, including circuitry for obtaining 1421, circuitry for transmitting 1422, circuitry for estimating 1423, and circuitry for determining 1424. Processing with circuitry 1421-1424 may enable and cause the communications device 1400 to perform the method 1200 as described with respect to FIG. 12, or any aspect related to it.

Various components of the communications device 1400 may provide means for performing the method 1200 as described with respect to FIG. 12, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, the transceivers 354, antenna(s) 352, transmit processor 364, TX MIMO processor 366, AI processor 370, and/or controller/processor 380 of the UE 104 illustrated in FIG. 3, transceiver 1408, antenna 1410, and/or network interface 1412 of the communications device 1400 in FIG. 14, and/or one or more processors 1420 of the communications device 1400 in FIG. 14. Means for communicating, receiving or obtaining may include the transceivers 332, antenna(s) 334, receive processor 338, AI processor 318, and/or controller/processor 340 of the BS 102 illustrated in FIG. 3, the transceivers 354, antenna(s) 352, receive processor 358, AI processor 370, and/or controller/processor 380 of the UE 104 illustrated in FIG. 3, transceiver 1408, antenna 1410, and/or network interface 1412 of the communications device 1400 in FIG. 14, and/or one or more processors 1420 of the communications device 1400 in FIG. 14. In certain aspects, means for estimating and determining of the method 1200 described with respect to FIG. 12, or any aspect related to it, may include controller/processor 340 of the BS 102 illustrated in FIG. 3, controller/processor 380 of the UE 104 illustrated in FIG. 3, and/or one or more processors 1420 of the communications device 1400 in FIG. 14.

### Example Clauses

Implementation examples are described in the following numbered clauses:

Clause 1: A method, comprising: obtaining a first signal communicated according to a first polarization; obtaining a second signal communicated according to a second polarization; and transmitting an indication of an imbalance between a signal strength of the first signal and a signal strength of the second signal.

Clause 2: The method of Clause 1, wherein the indication of the imbalance indicates that a difference between the signal strength of the first signal and the signal strength of the second signal satisfies a threshold.

Clause 3: The method of any one of Clauses 1-2, wherein the first signal is associated with a first antenna panel of a node and the second signal is associated with a second antenna panel of the node.

Clause 4: The method of Clause 3, wherein each of the first antenna panel and the second antenna panel comprise: a uni-polarized array; or a dual-polarized array.

Clause 5: The method of any one of Clauses 1-4, further comprising: obtaining a first reference signal at a first position of the apparatus; obtaining a second reference signal at a second position of the apparatus; obtaining a third reference signal; and obtaining a fourth reference signal.

Clause 6: The method of Clause 5, wherein: the first reference signal, the second reference signal, and the third reference signal are associated with a first antenna panel of a node; and the fourth reference signal is associated with a second antenna panel of the node.

Clause 7: The method of any one of Clauses 5-6, further comprising: transmitting an indication of a path loss estimate.

Clause 8: The method of Clause 7, wherein the path loss estimate is based on a signal strength of the first reference signal, a signal strength of the second reference signal, and a distance between the first position and the second position.

Clause 9: The method of any one of Clauses 7-8, further comprising: transmitting an indication of a differential signal strength between a signal strength of the third reference signal and a signal strength of the fourth reference signal.

Clause 10: The method of any one of Clauses 5-9, further comprising: transmitting a first estimated distance between a center of a first antenna panel of a node and the apparatus.

Clause 11: The method of Clause 10, further comprising: transmitting a second estimated distance between a center of a second antenna panel of the node and the apparatus.

Clause 12: The method of Clause 11, wherein the second estimated distance is based on a signal strength of the first reference signal, a signal strength of the second reference signal, a distance between the first position and the second position, a signal strength of the third reference signal, and a signal strength of the fourth reference signal.

Clause 13: The method of any one of Clauses 1-12, further comprising: obtaining a first reference signal; obtaining a second reference signal; and transmitting an indication of an observed time difference of arrival associated with the first reference signal and the second reference signal.

Clause 14: The method of Clause 13, wherein the first reference signal is associated with a first antenna panel of a node and the second reference signal is associated with a second antenna panel of the node.

Clause 15: A method, comprising: transmitting a first signal according to a first polarization; transmitting a second signal according to a second polarization; and obtaining an indication of an imbalance between a signal strength of the first signal and a signal strength of the second signal.

Clause 16: The method of Clause 15, wherein the indication of the imbalance indicates that a difference between the signal strength of the first signal and the signal strength of the second signal satisfies a threshold.

Clause 17: The method of any one of Clauses 15-16, wherein the first signal is associated with a first antenna panel of the apparatus and the second signal is associated with a second antenna panel of the apparatus.

Clause 18: The method of Clause 17, wherein each of the first antenna panel and the second antenna panel comprises: a uni-polarized antenna array; or a dual-polarized antenna array.

Clause 19: The method of any one of Clauses 15-18, further comprising: transmitting a first reference signal; transmitting a second reference signal; transmitting a third reference signal; and transmitting a fourth reference signal.

Clause 20: The method of Clause 19, wherein: the first reference signal, the second reference signal, and the third reference signal are sent from a first antenna panel of the apparatus; and the fourth reference signal is transmitted from a second antenna panel of the apparatus.

Clause 21: The method of any one of Clauses 19-20, further comprising: obtaining, based on transmitting the first reference signal and the second reference signal, an indication of a path loss estimate.

Clause 22: The method of Clause 21, further comprising: obtaining an indication of a differential signal strength between a signal strength of the third reference signal and a signal strength of the fourth reference signal.

Clause 23: The method of Clause 22, further comprising: obtaining an indication of a first estimated distance between a center of a first antenna panel of the apparatus and a node; determining a distance ratio of the first estimated distance to a second estimated distance between a center of a second antenna panel of the apparatus and the node based on the path loss estimate and the differential signal strength; determining the second estimated distance based on the first estimated distance and the distance ratio; transmitting a third signal from the first antenna panel of the apparatus according to a first direction, wherein the first direction is based on a transmission configuration indication state; and transmitting a fourth signal from the second antenna panel of the apparatus according to a second direction, wherein the second direction is based on the first estimated distance, the second estimate distance, and a distance between the center of the first antenna panel to the center of the second antenna panel.

Clause 24: The method of any one of Clauses 19-23, further comprising: obtaining a first estimated distance between a center of a first antenna panel of the apparatus and a node and a second estimated distance between a center of a second antenna panel of the apparatus and the node.

Clause 25: The method of Clause 24, further comprising: transmitting a third signal from the first antenna panel of the apparatus according to a first direction, wherein the first direction is based on a transmission configuration indication state; and transmitting a fourth signal from the second antenna panel of the apparatus according to a second direction, wherein the second direction is based on the first estimated distance, the second estimate distance, and a distance between the center of the first antenna panel to the center of the second antenna panel.

Clause 26: The method of any one of Clauses 15-25, further comprising: transmitting a first reference signal; transmitting a second reference signal; and obtaining an indication of a respective observed time difference of arrival associated with each of the first reference signal and the second reference signal.

Clause 27: The method of Clause 26, wherein the first reference signal is associated with a first antenna panel of the apparatus and the second reference signal is associated with a second antenna panel of the apparatus.

Clause 28: The method of any one of Clauses 26-27, further comprising: determining a difference between the respective observed time difference of arrival associated with the first reference signal and the respective observed time difference of arrival associated with the second reference signal; transmitting a third signal from a first antenna panel according to a first direction, wherein the first direction is based on a transmission configuration indication state; and transmitting a fourth signal from a second antenna panel of the apparatus according to a second direction, wherein the second direction is based on the difference.

Clause 29: One or more apparatuses, comprising: one or more memories comprising executable instructions; and one or more processors configured to execute the executable instructions and cause the one or more apparatuses to perform a method in accordance with any one of clauses 1-28.

Clause 30: One or more apparatuses, comprising: one or more memories; and one or more processors, coupled to the one or more memories, configured to cause the one or more apparatuses to perform a method in accordance with any one of Clauses 1-28.

Clause 31: One or more apparatuses, comprising: one or more memories; and one or more processors, coupled to the one or more memories, configured to perform a method in accordance with any one of Clauses 1-28.

Clause 32: One or more apparatuses, comprising means for performing a method in accordance with any one of Clauses 1-28.

Clause 33: One or more non-transitory computer-readable media comprising executable instructions that, when executed by one or more processors of one or more apparatuses, cause the one or more apparatuses to perform a method in accordance with any one of Clauses 1-28.

Clause 34: One or more computer program products embodied on one or more computer-readable storage media comprising code for performing a method in accordance with any one of Clauses 1-28.

Clause 35: A UE, comprising: a processing system that includes processor circuitry and memory circuitry that stores code and is coupled with the processor circuitry, the processing system configured to cause the UE to perform a method in accordance with any one of Clauses 1-28.

Clause 36: A network entity, comprising: a processing system that includes processor circuitry and memory circuitry that stores code and is coupled with the processor circuitry, the processing system configured to cause the network entity to perform a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain a first signal communicated according to a first polarization;
obtain a second signal communicated according to a second polarization; and
transmit an indication of an imbalance between a signal strength of the first signal and a signal strength of the second signal.

2. The apparatus of claim 1, wherein the indication of the imbalance indicates that a difference between the signal strength of the first signal and the signal strength of the second signal satisfies a threshold.

3. The apparatus of claim 1, wherein the first signal is associated with a first antenna panel of a node and the second signal is associated with a second antenna panel of the node.

4. The apparatus of claim 3, wherein each of the first antenna panel and the second antenna panel comprises:
a uni-polarized antenna array; or
a dual-polarized antenna array.

5. The apparatus of claim 1, wherein the one or more processors are configured to cause the apparatus to:
obtain a first reference signal at a first position of the apparatus;
obtain a second reference signal at a second position of the apparatus;
obtain a third reference signal; and
obtain a fourth reference signal.

6. The apparatus of claim 5, wherein:
the first reference signal, the second reference signal, and the third reference signal are associated with a first antenna panel of a node; and
the fourth reference signal is associated with a second antenna panel of the node.

7. The apparatus of claim 5, wherein the one or more processors are configured to cause the apparatus to:
transmit an indication of a path loss estimate.

8. The apparatus of claim 7, wherein the path loss estimate is based on a signal strength of the first reference signal, a signal strength of the second reference signal, and a distance between the first position and the second position.

9. The apparatus of claim 7, wherein the one or more processors are configured to cause the apparatus to:
transmit an indication of a differential signal strength between a signal strength of the third reference signal and a signal strength of the fourth reference signal.

10. The apparatus of claim 5, wherein the one or more processors are configured to cause the apparatus to:
transmit a first estimated distance between a center of a first antenna panel of a node and the apparatus.

11. The apparatus of claim 10, wherein the one or more processors are configured to cause the apparatus to:
transmit second estimated distance between a center of a second antenna panel of the node and the apparatus.

12. The apparatus of claim 11, wherein the second estimated distance is based on a signal strength of the first reference signal, a signal strength of the second reference signal, a distance between the first position and the second position, a signal strength of the third reference signal, and a signal strength of the fourth reference signal.

13. The apparatus of claim 1, wherein the one or more processors are configured to cause the apparatus to:
obtain a first reference signal;
obtain a second reference signal; and
transmit an indication of a respective observed time difference of arrival associated with each of the first reference signal and the second reference signal.

14. The apparatus of claim 13, wherein the first reference signal is associated with a first antenna panel of a node and the second reference signal is associated with a second antenna panel of the node.

15. An apparatus configured for wireless communications, comprising:
one or more memories; and
one or more processors coupled to the one or more memories, the one or more processors being configured to cause the apparatus to:
transmit a first signal according to a first polarization;
transmit a second signal according to a second polarization; and
obtain an indication of an imbalance between a signal strength of the first signal and a signal strength of the second signal.

16. The apparatus of claim 15, wherein the indication of the imbalance indicates that a difference between the signal strength of the first signal and the signal strength of the second signal satisfies a threshold.

17. The apparatus of claim 15, wherein the first signal is associated with a first antenna panel of the apparatus and the second signal is associated with a second antenna panel of the apparatus.

18. The apparatus of claim 17, wherein each of the first antenna panel and the second antenna panel comprises:
a uni-polarized antenna array; or
a dual-polarized antenna array.

19. The apparatus of claim 15, wherein the one or more processors are configured to cause the apparatus to:
transmit a first reference signal;
transmit a second reference signal;
transmit a third reference signal; and
transmit a fourth reference signal.

20. The apparatus of claim 19, wherein:
the first reference signal, the second reference signal, and the third reference signal are sent from a first antenna panel of the apparatus; and
the fourth reference signal is transmitted from a second antenna panel of the apparatus.

21. The apparatus of claim 19, wherein the one or more processors are configured to cause the apparatus to:
obtain, based on transmitting the first reference signal and the second reference signal, an indication of a path loss estimate.

22. The apparatus of claim 21, wherein the one or more processors are configured to cause the apparatus to:
obtain an indication of a differential signal strength between a signal strength of the third reference signal and a signal strength of the fourth reference signal.

23. The apparatus of claim 22, wherein the one or more processors are configured to cause the apparatus to:
obtain an indication of a first estimated distance between a center of a first antenna panel of the apparatus and a node;
determine a distance ratio of the first estimated distance to a second estimated distance between a center of a second antenna panel of the apparatus and the node based on the path loss estimate and the differential signal strength;
determine the second estimated distance based on the first estimated distance and the distance ratio;
transmit a third signal from the first antenna panel of the apparatus according to a first direction, wherein the first direction is based on a transmission configuration indication state; and
transmit a fourth signal from the second antenna panel of the apparatus according to a second direction, wherein the second direction is based on the first estimated distance, the second estimate distance, and a distance between the center of the first antenna panel to the center of the second antenna panel.

24. The apparatus of claim 19, wherein the one or more processors are configured to cause the apparatus to:
obtain a first estimated distance between a center of a first antenna panel of the apparatus and a node and a second estimated distance between a center of a second antenna panel of the apparatus and the node.

25. The apparatus of claim 24, wherein the one or more processors are configured to cause the apparatus to:
transmit a third signal from the first antenna panel of the apparatus according to a first direction, wherein the first direction is based on a transmission configuration indication state; and
transmit a fourth signal from the second antenna panel of the apparatus according to a second direction, wherein the second direction is based on the first estimated distance, the second estimate distance, and a distance between the center of the first antenna panel to the center of the second antenna panel.

26. The apparatus of claim 15, wherein the one or more processors are configured to cause the apparatus to:
transmit a first reference signal;
transmit a second reference signal; and
obtain an indication of a respective observed time difference of arrival associated with each of the first reference signal and the second reference signal.

27. The apparatus of claim 26, wherein the first reference signal is associated with a first antenna panel of the apparatus and the second reference signal is associated with a second antenna panel of the apparatus.

28. The apparatus of claim 26, wherein the one or more processors are configured to cause the apparatus to:
determine a difference between the respective observed time difference of arrival associated with the first reference signal and the respective observed time difference of arrival associated with the second reference signal;
transmit a third signal from a first antenna panel according to a first direction, wherein the first direction is based on a transmission configuration indication state; and
transmit a fourth signal from a second antenna panel of the apparatus according to a second direction, wherein the second direction is based on the difference.

29. A method for wireless communications by an apparatus, comprising:
obtaining a first signal communicated according to a first polarization;
obtaining a second signal communicated according to a second polarization; and
transmitting an indication of an imbalance between a signal strength of the first signal and a signal strength of the second signal.

30. A method for wireless communications by an apparatus, comprising:
transmitting a first signal according to a first polarization;
transmitting a second signal according to a second polarization; and
obtaining an indication of an imbalance between a signal strength of the first signal and a signal strength of the second signal.
